(19) United States
(12) Patent Application Publication
(10) Pub. No.: US 2021/0033192 A1
(43) Pub. Date: Feb. 4, 2021

(54) AXIALLY PRELOADED PACKING RING SETS

(71) Applicant: ARIEL CORPORATION, Mt. Vernon, OH (US)

(72) Inventors: Evan William KOONTZ, Howard, OH (US); Gregory Ray LORTIE, Mount Vernon, OH (US)

(21) Appl. No.: 16/941,284

(22) Filed: Jul. 28, 2020

Related U.S. Application Data
(60) Provisional application No. 62/879,848, filed on Jul. 29, 2019.

(51) Int. Cl. F16J 9/06

(52) U.S. Cl. CPC F16J 9/06

(57) ABSTRACT

An apparatus including a sealing element with at least one pilot feature on a first face, and at least one device configured to apply radial force on an outer diameter of the sealing element. The apparatus further includes at least one wave spring comprising at least one flat end-coil and disposed around the at least one pilot feature of the sealing element.

### CROSS REFERENCE TO RELATED APPLICATION

This application claims the benefit of U.S. Provisional Application No. 62/879,848, filed Jul. 29, 2019. The entire content of the above-referenced application is hereby incorporated by reference.

### TECHNICAL FIELD

Some example embodiments may generally relate to packing ring sets. For example, certain example embodiments may relate to reciprocating compressor packing ring sets and oil wiper sets axially preloaded with a one-piece, multi-turn wave spring with flat end-coils.

### BACKGROUND

In positive displacement reciprocating gas compressors, the reciprocating motion of a double-acting piston causes gas to be compressed on both ends of a piston within a cylinder. One end of a piston rod is connected to the double-acting piston, and extends through an opening in the crank-end cylinder head. The opposing end of the piston rod is then connected to the remainder of the drive train to provide the reciprocating motion. Pressure packing may utilize a seal to prevent gas from escaping through an annular opening between the crank-end cylinder head and the reciprocating piston rod.

In particular, pressure packing seals the working pressure in the cylinder, and diverts any leaking gas into a ventilation system configured for proper disposal or other processing. Pressure packing can use a wide variety of pressure breakers and main packing ring sets to seal the working pressure within the cylinder. These pressure breakers and main packing ring sets can include a plurality of individual packing rings, and each pressure breaker or main packing ring set can be housed in an individual packing cup within the packing case.

### SUMMARY

In accordance with various embodiments, an apparatus may include a sealing element with at least one pilot feature on a first face, and at least one device configured to apply radial force on an outer diameter of the sealing element. The apparatus may further include at least one wave spring with at least one flat end-coil and disposed around the at least one pilot feature of the sealing element.

In accordance with some embodiments, an apparatus may include a first sealing element with at least one pilot feature on a first face, and at least one device configured to apply radial force on an outer diameter of the first sealing element. The apparatus may further include a wave spring with at least one flat end-coil and disposed adjacent to the first face of the first sealing element. The apparatus may further include a second sealing element with at least one pilot disposed on a first face adjacent to the wave spring, and at least one device configured to apply radial force on an outer diameter of the second sealing element.

### BRIEF DESCRIPTION OF THE DRAWINGS

For proper understanding of example embodiments, reference should be made to the accompanying drawings, wherein:

FIG. 1A illustrates an exploded view of a first example of a unidirectional packing main/vent ring set according to certain embodiments.

FIG. 1B illustrates a top view of the first example of a unidirectional packing main/vent ring set according to some embodiments.

FIG. 1C illustrates a cross sectional view from the side of the first example of a unidirectional packing main/vent ring set according to various embodiments.

FIG. 2A illustrates an exploded view of a second example of a unidirectional packing main/vent ring set according to certain embodiments.

FIG. 2B illustrates a top view of the second example of a unidirectional packing main/vent ring set according to some embodiments.

FIG. 2C illustrates a cross sectional view from the side of the second example of a unidirectional packing main/vent ring set according to various embodiments.

FIG. 3A illustrates an exploded view of an example of a bidirectional packing purge ring set according to certain embodiments.

FIG. 3B illustrates a top view of the example of a bidirectional packing purge ring set with tangential cut according to some embodiments.

FIG. 3C illustrates a cross sectional view from the side of the example of a bidirectional packing purge ring set according to various embodiments.

FIG. 4A illustrates an exploded view of a first example of a unidirectional oil wiper according to certain embodiments.

FIG. 4B illustrates a top view of the first example of a unidirectional oil wiper with radial cut according to some embodiments.

FIG. 4C illustrates a cross sectional view from the side of the first example of a unidirectional oil wiper according to various embodiments.

FIG. 4D illustrates another cross sectional view from the side of the first example of a unidirectional oil wiper according to certain embodiments.

FIG. 4E illustrates another cross sectional view from the side of the first example of a unidirectional oil wiper according to some embodiments.

FIG. 5A illustrates an exploded view of a second example of a unidirectional oil wiper according to certain embodiments.

FIG. 5B illustrates a top view of the second example of a unidirectional oil wiper according to some embodiments.

FIG. 5C illustrates a cross sectional view from the side of the second example of a unidirectional oil wiper according to various embodiments.

FIG. 5D illustrates a cross sectional view from the side of the second example of a unidirectional oil wiper according to certain embodiments.

FIG. 6A illustrates an exploded view of an example of a multi-function, bidirectional oil wiper according to some embodiments.

FIG. 6B illustrates a top view of the example of a multi-function, bidirectional oil wiper according to some embodiments.

FIG. 6C illustrates a cross sectional view from the side of the example of a multi-function, bidirectional oil wiper according to some embodiments.

FIG. 6D illustrates another cross sectional view from the side of the example of a multi-function, bidirectional oil wiper according to some embodiments.

FIG. 6E illustrates another cross sectional view from the side of the example of a multi-function, bidirectional oil wiper according to some embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of apparatuses for a shaft sealing ring set used in reciprocating compressor packing ring sets and oil wiper sets is not intended to limit the scope of certain embodiments, but is instead representative of selected example embodiments.

In order to more efficiently energize and provide an effective seal, pressure breakers and main packing ring sets can be positioned in close contact with the packing cup and reciprocating piston rod. Close radial and circumferential contact with the reciprocating piston rod can be achieved using springs on the outer diameter of packing ring. In addition, reciprocating motion of the piston rod can create close axial contact with the packing cup. However, the reciprocating motion of the piston rod only creates close contact with the packing cup during a small portion of the stroke.

Energizing pressure breakers and main packing ring sets can create a seal in the radial, circumferential, and/or axial directions by high-pressure cylinder differential gas pressure. Thus, pressure breakers and main packing ring sets are not self-energizing, and require a differential pressure to energize. Energizing of the pressure breakers and main packing ring sets also maintains close axial contact with the packing cup. However, using a pressure packing without reciprocating motion to create close axial contact may lose the ability to energize and make a seal. With no additional source of differential gas pressure to maintain close axial contact and energize, any additional main packing ring sets in the packing case, such as with a quantity greater than two, do not create seals or share loads.

A seal can be created when the contact pressure between sealing surfaces of the pressure breaker or main packing ring set and the cup face and piston rod is at least the given differential pressure. The differential pressure energizing design of pressure breakers and main packing ring sets allows them to apply enough contact pressure to maintain a seal, thereby regulating the contact pressure since any additional contact pressure would not contribute to creating a seal. Rather, this additional contact would accelerate the failure of sealing components.

The packing case may also include a vent opening after the last main packing ring set. The vent ring could be located after the vent opening, and is intended to force any leaking low-pressure cylinder gas to escape through the vent opening. Since the vent opening only transfers low-pressure cylinder gas, the vent opening is unsuitable to keep a vent ring set energized to make a seal with the packing cup. Without axial preload on the vent ring set, it will axially oscillate inside the packing cup due to friction from the motion of the piston rod. As a result, gas will leak past any packing ring set as it oscillates in the packing cup.

At the frame end of the piston rod, a wiper packing prevents low-pressure cylinder gas from entering the compressor frame while also preventing compressor frame oil from seeping down the piston rod towards the pressure packing. Any low-pressure cylinder gas that may exist in front of the wiper packing would have leaked beyond the vent ring set in the pressure packing, between packing cup mating faces, between packing gaskets, and/or other areas. The wiper packing has an axially preloaded vent ring set to seal low-pressure cylinder gas from entering the compressor frame. Compressor frame oil on the other side of the wiper packing may splash onto the wiper packing. The wiper packing could also contain an oil wiper to wipe oil from the reciprocating piston rod and drain it into the compressor frame. An oil wiper is not a three-dimensional seal similar to a main packing ring set; instead, it is a two-dimensional wiper capable of sealing in the axial and circumferential directions, and configured to prevent oil migration along the piston rod in the axial and circumferential directions, while at the same time drain oil towards the radial direction. The radial direction is drilled or relieved to drain oil away from the piston rod. The radial drilling or relief allows a leak path in one of the three directions, rendering it a two-dimensional seal. Since most oil wipers are not axially loaded, the oil wiper oscillates in the groove with the reciprocating piston rod, allowing oil to be wicked along the interior surfaces of the cup housing the wiper, and migrating past the wiper. In order to operate within space constraints of some compressor models, the wiper packing could be integrated into the pressure packing.

For applications requiring compression of toxic and/or corrosive gasses, an intermediate packing may be used between the pressure packing and wiper packing. An intermediate packing provides a positive pressure barrier seal to prevent the toxic and/or corrosive gases from migrating from the pressure packing towards the wiper packing and compressor frame. The intermediate packing contains a positive pressure, axially preloaded, bi-directional purge ring set. Positive pressure can be created with the seal being treated with non-toxic, non-corrosive, and/or inert purge gas. Purge gas pressure is frequently low, such as 1 atmosphere (atm), and, even without axial preload, may be insufficient to maintain close axial contact with both sides of the packing cup at the same time during all operating conditions.

Unlike the axially preloaded vent ring, this purged version must be capable of sealing toxic and corrosive low-pressure cylinder gas from migration, as well as seal purge gas from escaping the ring set, making it bi-directional. In these applications, the axially preloaded vent ring sets in the pressure packing and wiper packing are also changed to positive-pressure, axially-preloaded, bi-directional purge ring sets to create a series of redundant, positive-pressure barrier seals to prevent toxic or corrosive low-pressure cylinder gas from migrating into the compressor frame.

Different mechanisms may generate the axial preload for packing vent and purge ring sets, such as wedge-activated and coil spring-activated. Wedge-activated designs use the radial spring force from a single, non-sealing, individual radial packing ring with wedge-in feature to push both radially and axially on an adjacent individual radial packing ring with a wedge-out feature. The radial wedge-out ring is disposed adjacent to, and in face contact with, an individual step-tangent packing ring. The wedge-activated packing vent ring set would include the radial wedge-in (single wedge), radial wedge-out, and step-tangent individual packing rings. The wedge-activated vent ring set is housed in a single packing cup, where both the radial wedge-out and step-tangent individual packing rings are sealing elements. The axial load generated by the radial wedge-in ring is transmitted through both the radial wedge-out and step-tangent individual packing rings to keep them in close axial contact with each other and the packing cup. The radial spring force of the radial wedge-out ring can cover the end gaps on the step-tangent ring. The added radial force on the radial wedge-out ring from the non-sealing radial wedge-in ring adds to the total radial force on the radial wedge-out ring. However, this added radial force on the radial wedge-out ring does not improve seals, but rather generates extra heat during operation.

In contrast, the wedge-activated purge ring set includes a single, non-sealing, individual radial packing ring with wedge-in feature (dual wedge) and two sets of opposed and adjacent radial packing rings with wedge-out feature and step-tangent individual packing rings. The wedge-activated packing purge ring set is housed in a single packing cup. Since there are two individual radial wedge-out packing rings in the wedge-activated purge ring set, it has two radial rings which generate additional heat. An alternate arrangement of two wedge-activated vent ring sets can be configured to create a purge ring set. In this configuration, two wedge-activated vent rings are housed in two individual packing cups and face opposite each other. However, this alternate arrangement takes up more axial space than one wedge-activated purge ring set. In addition, wedge-activated vent and purge rings can add enough frictional heat to cause packing failures, and/or require the added complexity of a coolant system for the pressure packing.

Coil spring activated designs position multiple axial coil springs around the piston rod to apply axial force to a pressure plate that then applies an axial preload to either a radial/step-tangent individual packing ring pair or a step-tangent/step-tangent individual packing ring pair. This design may eliminate the extra unnecessary radial load of the wedge-activated design, but takes up the space of one or more cups to make the design work. There may not be enough axial space in the compressor for the coil spring activated designs, prohibiting compressor operators from running at conditions that generate higher temperatures, or running without the added complexity of a coolant system for the pressure packing.

Packing ring sets can be designed for installation with the piston rod in place. Many compressors are not conducive for easy maintenance, and packing ring sets can be installed with the piston rod in place. Both the wedge-activated and coil spring activated axially preloaded packing ring sets rely on complex, multi-piece assemblies to enable all of the rings and springs of the packing ring sets to be installed with the piston rod in place. In some variations, the piston rod in a compressor is the easiest part of the drive train to remove or install, allowing for easy access to the packings. As a result, packings allow for proper packing maintenance without complex multi-piece technologies. By removing the piston rod before doing packing maintenance, mechanics can evaluate the condition of the piston rod before re-installing. The piston rod is part of the sealing system, and may also need maintenance for proper function. Piston rods designed to be installed and removed with the packing in place allow for the use of one-piece or solid packing rings which can provide superior performance to multi-piece packing rings.

An individual packing ring or oil wiper ring may include three segments held together with a garter spring located at the outer diameter. Two basic types of segments are radial and tangent. When installed on the piston rod, the individual packing ring generally has end gaps between each segment. When two individual packing rings or oil wiper rings are positioned adjacent to each other to make a seal set, they are generally aligned with the end gaps out of phase by the use of a peg in one ring, and a clearance hole or slot in the other ring. An individual segmented packing ring or oil wiper ring alone may not be sufficient to create a seal. Thus, a single pressure-balanced packing ring can be used in place of a pair of segmented individual packing rings to make a complete seal. A single tangent-to-rod packing ring can also be used in place of a pair of segmented individual packing rings to make a complete seal.

A packing ring set or oil wiper includes a minimum number of packing rings, spring, and/or pegs required to establish a seal and/or prevent oil migration. The packing ring set or oil wiper may also be housed in a packing cup. Similarly, a packing case is an assembly of empty packing cups, packing plates, and packing flanges needed to house the packing rings sets. With these components, the packing includes an assembly of packing ring sets (pressure breakers), main packing ring sets, vent or purge ring sets, and oil wipers in the empty packing case. Packings may be more specifically defined as pressure packing, intermediate packing, and wiper packing. Packing ring sets must be contained within the packing cups to properly function, yet because the packing cups may outlast the packing ring sets, the packing ring sets may be individually available to simplify replacement. During replacement, the metal packing cups can be re-machined to meet new specifications, while packing ring sets are disposed and replaced with new ring sets.

Certain embodiments described herein may have various benefits and/or advantages to overcome the disadvantages described above. For example, certain embodiments may be housed in a single packing cup, such as compact, wedge-activated packing rings, while generating less heat compared to bulkier, multi-cup, coil spring preloaded packing rings. Various embodiments may also be much simpler than conventional designs, and are easily installed or removed with the piston rod removed in many maintenance-friendly compressors.

Some embodiments may also cause lower heat generation of the more axially space consuming coil spring activated designs in a more axially compact single packing cup design, such as wedge-activated designs. The axially preloaded packing purge ring set configuration may also serve as a convenient drop-in replacement for the wedge-activated packing purge ring set. The flat end-coils of the one-piece, multi-turn wave spring may eliminate the need for extra pieces and added complexity to distribute the axial preload against the packing rings.

Described herein are various embodiments of shaft sealing ring sets configured for use in reciprocating compressor packing ring sets and oil wiper sets that are axially preloaded with a one-piece, multi-turn wave spring with flat end-coils. Axially preloaded packing rings may be used to create or maintain close axial contact regardless of the magnitude of piston rod motion and/or differential pressure applied. Such axial preload on certain ring sets can allow new functions and/or improve existing functions of a given ring set where certain challenging conditions exist, such as zero reciprocating piston rod motion, low differential gas pressure, and/or zero pressure fluid, i.e., oil.

Various embodiments can include any quantity, type, and combination of packing rings on one side of the one-piece, multi-turn wave spring with flat end coils; any quantity, type, and combination of individual packing rings on the other side of the one-piece, multi-turn wave spring with flat end coils; and/or any quantity, type, and combination of individual packing rings on both sides of the one-piece, multi-turn wave spring with flat end coils. Furthermore, individual packing rings may include one or multiple pieces, radial or tangential cuts, springs on the outer diameter, pegs and slots or holes for alignment, radial holes and/or slots for draining, circumferential pilots, and/or wiping lands on the inner diameter configured to scrape oil. Ring sets may be configured to make static or dynamic seals; one, two, or three-dimensional seals; and/or be unidirectional or bidirectional in function along the axis of the piston rod. Some embodiments of the one-piece, multi-turn, wave spring with flat end coils may have end treatments or a partial or complete absence of one or both of the flat end coils.

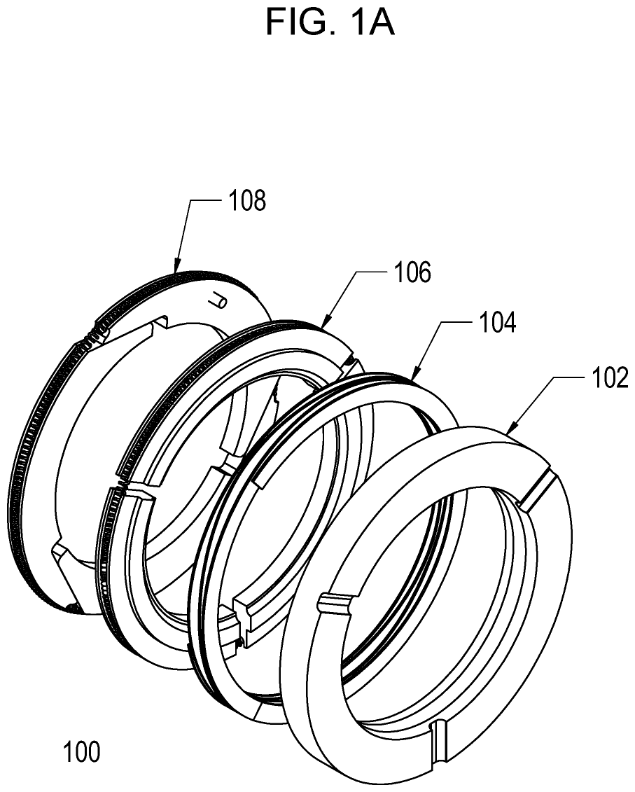

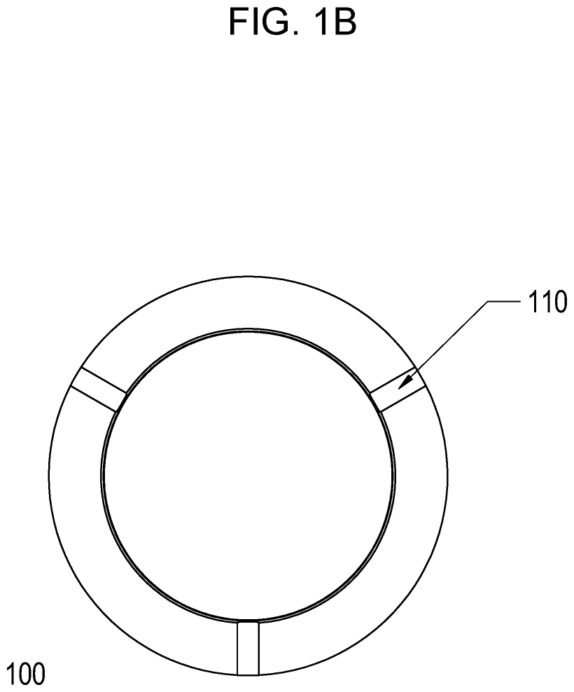

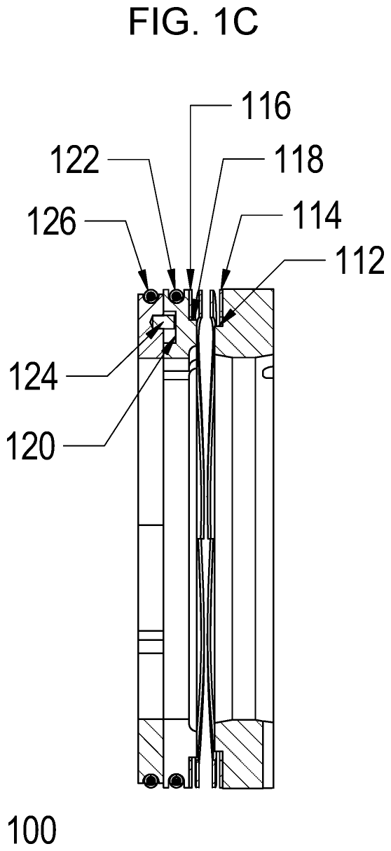

As illustrated in FIGS. 1A-1C, unidirectional packing main/vent ring set 100 may include at least one element 102, such as a one-piece, radially vented spring plate ring, including at least one pilot feature 112 on a first face, and at least one device configured to apply radial force on an outer diameter of element 102, as shown in FIG. 1A. Ring set 100 may be configured to make a static or dynamic three-dimensional seal.

In various embodiments, ring set 100 may also include at least one one-piece, multi-turn wave spring 104 including at least one flat end-coil and/or disposed around the at least one pilot feature 112 of element 102. Wave spring 104 may include at least one flat end-coil that pilots on the adjacent rings. Furthermore, ring set 100 may include at least one adjacent 3-piece radial packing ring 106 with at least one pilot feature on one face for the wave spring and/or a slot feature on the opposite side for alignment and/or at least one garter spring on the outer diameter. Additionally or alternatively, ring set 100 may include at least one adjacent 3-piece step-tangent packing ring 108 with at least one peg to mate with and align to the at least one radial packing ring 106 and at least one garter spring 126 on the outer diameter.

In various embodiments, element 102 may include at least one radial vent notch 110, where FIG. 1B illustrates three such vent notches. Turning to FIG. 1C, pilot 112 disposed on element 102 may be configured to align with wave spring 104. Element 104 may also include at least one of flat end coil 114 and flat end coil 116. Similarly, element 106 may include one or more of pilot 118 configured to align with wave spring 104, slot 120 configured to align with at least one peg disposed on element 108, and at least one garter spring 122. FIG. 1C further illustrates element 108 having at least one peg 124 configured to align with at least one slot in element 106. Finally, element 108 may also have at least one garter spring 126.

In various embodiments, any number, type, and/or combination of individual rings may be used on either one or both sides of wave spring 104. Radial rings, with or without pilot, may have any number of cuts. Thus, the radial ring may be 1-piece with a single end gap (cut), or composed of 2 or more segments with an equal number of end gaps (cuts). A vented spring plate may be one-piece, or multi-piece with a garter spring. Some embodiments may be used with any kind of tangent ring between the radial ring (with pilot) and a cup face. Tangent ring types may include step-tangent (tangent to a diameter larger than the piston rod), true-tangent (tangent to the piston rod), tangent-to-rod (tangent to a diameter smaller than the piston rod) and 6-piece step-tangent (tangent to a diameter larger than the piston rod). Step-tangent, true-tangent, and tangent-to-rod rings may have at least one tangent segment. The radial ring with pilot feature may be replaced with any kind of tangent ring with pilot feature. As a result, the pair of tangent rings and radial rings with pilot feature may be a pair including a tangent ring and another tangent ring with pilot feature for the wave spring.

In some embodiments, on one or both sides of wave spring 104, the radial/tangent pair may be replaced with either a single pressure balanced ring with pilot feature, lip seal with pilot feature, or a single tangent-to-rod ring with pilot feature. A pressure balanced packing ring may be a single row of ring segments that are 3-dimensional in the plane of the ring. A tangent-to-rod ring may be configured to make a seal as a single ring until wear occurs. In addition, any or all of the rings may contain oil wiping edges at the inside diameter of the ring. Some embodiments may include at least one backup ring of either segmented (with at least one spring on the outer diameter) or solid design located between the tangent ring and the packing cup. Furthermore, the material of the radial ring, tangent ring, and spring plate may be any non-metallic or metallic material. The slot feature for alignment with the at least one peg may extend radially all the way across the radial thickness, and/or can be terminated at each end of the radial slot.

In certain embodiments, the slot feature may be machined at any angle other than radial to the ring. The slot feature may also be substituted by a hole for alignment with at least one peg and/or multiple slots and pegs may be used. The peg material may also be any non-metallic or metallic material, and the alignment of the rings via the peg may also be achieved by other means. The peg may be in the tangent ring, and the slot may be in the radial ring, but it may also be manufactured with the peg in the radial ring and the slot in the tangent ring. Furthermore, segmented packing rings may use coil springs, solid wire springs, o-rings, and/or any circumferential element around the outer diameter of the ring to keep the segments in close radial contact with the piston rod.

In various embodiments, at least one garter spring and/or at least one solid wire spring material may be any spring grade metal. The one-piece, multi-turn wave spring with flat end-coils may be composed of a variety of materials, such as carbon steel, chrome-silicon, stainless steel, super alloys, other metals, and/or non-metallics. The one-piece, multi-turn wave spring with flat end-coils may also have a small end treatment to at least one of the flat end coils to prevent rotation of the spring relative to the ring with pilot feature. In addition, the one-piece, multi-turn wave spring with flat end-coils may have partial flat end-coil or an absence of the flat end-coil.

In some embodiments, more than one wave spring can be used. For example, two or more wave springs may be nested together to boost axial load. Two or more wave springs may also be concentrically located relative to each other. In addition, two or more wave springs may be in series axial to each other. The purge ring set configuration may be used as a main/vent ring, where no purge gas is applied. The main/vent ring set may be used in a positive pressure purged packing if high flow rate flushing is needed. Furthermore, the piston rod may be any diameter.

The shaft sealing ring set may create and maintain close axial contact of the packing ring and oil wiper sets with the packing cup while eliminating the additional radial force of the wedge-activated designs. The design of the wave spring is such that it may generate axial force when compressed without creating any radial force. Eliminating the additional radial force from wedge-activated designs may cause less force being applied to the piston rod, leading to reduced friction of the piston rod, less heat, and less wear. The axial force generated by wave spring 104 may be greater than the force of friction between all of the individual rings on one side of wave spring 104, whichever side is greater, and the piston rod. The one-piece design of wave spring 104 may require few additional parts and no additional cups to enhance the current, or create new functions of particular ring sets. Wave spring 104 may be centered around the piston rod by at least one circumferential pilot from either the adjacent individual ring or packing cup. Quasi-uniform contact pressure from wave spring 104 may be applied to the adjacent rings or cups via the flat end coils. Packing ring sets or oil wiper sets with a one-piece wave spring are most easily installed or removed with the piston rod removed from the compressor. Thus, it is generally easiest to plunge the piston rod through the packing ring sets with at least one one-piece wave spring. Any ring sets containing solid rings or rings that are very stiff may require installation and removal with the piston rod removed from the compressor. Depending upon the design, flexibility, and strength of wave spring 104, it may be possible to wind wave spring 104 on or off the piston rod with the piston rod installed in the compressor.

One or more individual rings in a packing ring set may be configured to make a three-dimensional seal between the packing cup face and the piston rod shaft. Gas pressure may act in all directions, requiring a three-dimensional seal. As an example, certain applications may require that gas be sealed from migrating in one direction, while other applications may require that two different types of gas be sealed, each from migrating in opposite directions.

The sealing surfaces of packing ring sets may be held in close radial and circumferential contact with the piston rod by a spring on the outer diameter and close axial contact with the packing cup faces by wave spring 104. Close contact may be the relative distance between sealing surfaces. Close contact may exist when the distance between sealing surfaces is small enough that when the source of energization is applied, the surfaces press together to generate contact pressure. If close contact does not exist, the source of energization will not press the sealing surfaces together and/or will not generate contact pressure. When reciprocating piston rod motion does not exist, wave spring 104 may create and maintain the close axial contact between the packing ring set faces and the packing cup face. The packing ring set with wave spring 104 may be capable of sealing gas even when there is no reciprocating piston rod motion.

The design of most packing rings may be such that differential pressure is what energizes the packing rings to generate contact pressure between the sealing surfaces. Thus, packing rings may not self-energize. Using differential pressure to energize may regulate the contact pressure between sealing surfaces, which self-limits the heat and wear that is generated for the application. Low differential pressure may not be enough to energize the packing rings such that the spring on the outer diameter and the wave spring do all of the energizing in these examples.

Given the existence of reciprocating piston rod motion, the wave spring may maintain close axial contact between the packing ring set faces and the packing cup face, and may provide the energization when low differential pressure exists. Even with reciprocating piston rod motion, the packing ring set with wave spring may be capable of sealing low differential pressure gas.

A seal may be made when the contact pressure between sealing surfaces of the packing ring set and the cup face and piston rod is equal to or greater than the given differential pressure. There may be two types of cylinder differential gas pressure. First, cyclic differential gas pressure may be the difference between suction and discharge, which fluctuates with compression. Second, static differential gas pressure may be the difference between suction and atmosphere, which does not fluctuate. These two types of cylinder differential gas pressure may be used to maintain close contact of generally only two packing ring sets within the packing case. With no additional source of differential gas pressure to maintain close axial contact on more than two packing ring sets, wave spring 104 may provide the additional source of close axial contact. With more than two packing ring sets maintaining close axial contact, load sharing between more than two packing ring sets can be enabled, which is the breakdown of differential pressure over more than two packing ring sets.

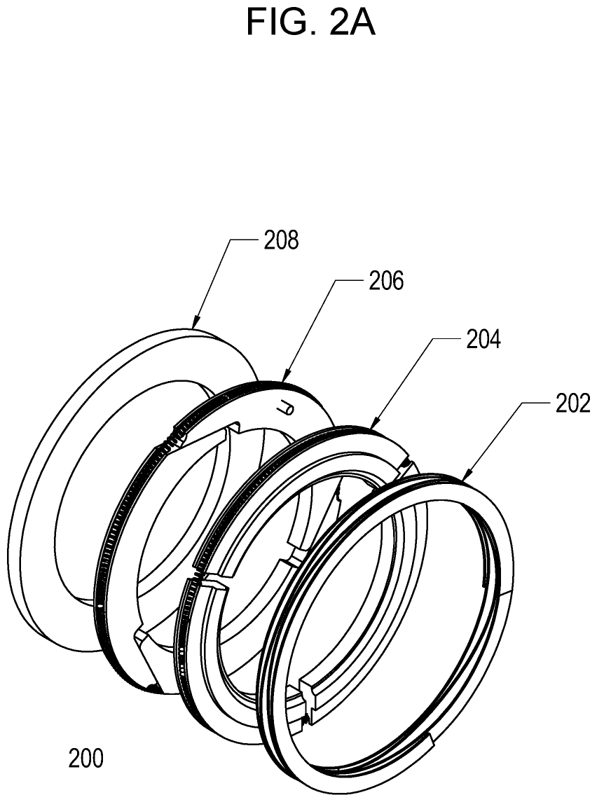

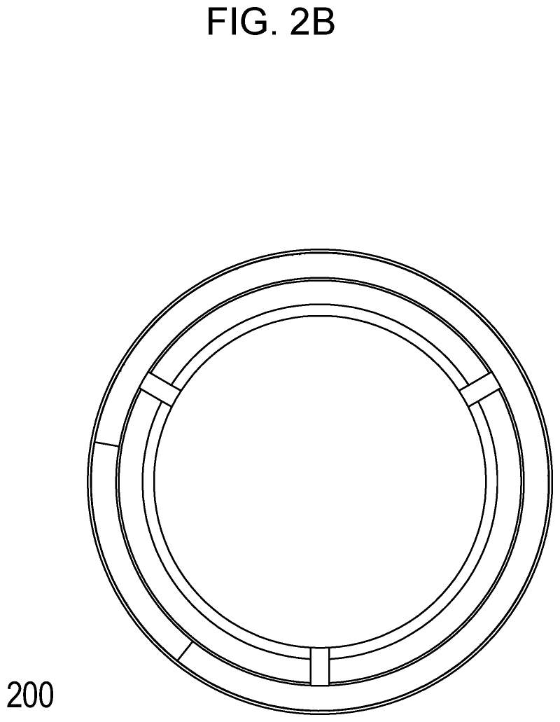

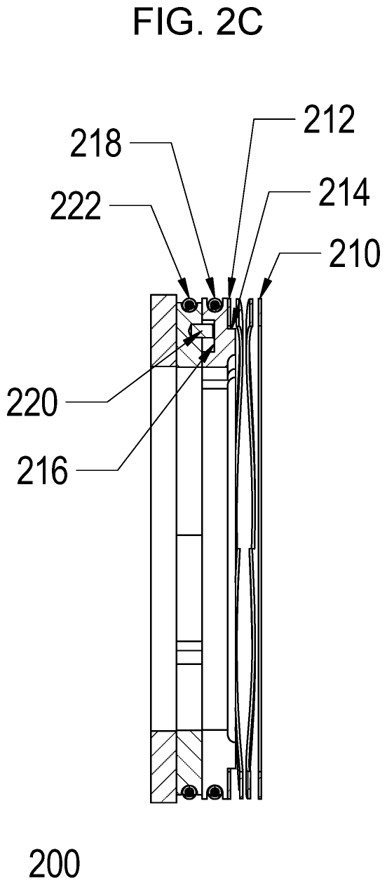

FIGS. 2A-2C illustrate an example of unidirectional packing main/vent ring set 200 configured to create a three-dimensional static or dynamic seal. In FIG. 2A, ring set 200 may include at least one one-piece, multi-turn wave spring 202 with at least one flat end-coil that pilots on an adjacent ring. Ring set 200 may further include at least one adjacent 3-piece radial packing ring 204 with at least one pilot feature on one face for the wave spring 202 and/or at least one slot feature on the opposite side for alignment and at least one garter spring on the outer diameter. 2B illustrates a top view of the second example of a unidirectional packing main/vent ring set according to some embodiments.

In various embodiments, ring set 200 may also include at least one adjacent 3-piece step-tangent packing ring 206 with at least one peg to mate with and align to radial packing ring 204. Additionally or alternatively, ring set 200 may also include an adjacent solid backup ring 208 with clearance over the piston rod.

According to some embodiments, as shown in FIG. 2C, element 202 may further include one or more of at least one flat end coil 210 and/or at least one flat end coil 212. Similarly, element 204 may further include one or more of at least one pilot 214 configured to center wave spring 202, at least one slot 216 configured to align with at least one peg in element 206, and at least one garter spring 218. Finally, element 206 may also include at least one peg 220 configured to align with at least one slot in element 204 and/or at least one garter spring 222.

In various embodiments, any number, type, and/or combination of individual rings may be used on either one or both sides of wave spring 202. Radial rings, with or without pilot, may have any number of cuts. Thus, the radial ring may be 1-piece with a single end gap (cut), or composed of 2 or more segments with an equal number of end gaps (cuts). A vented spring plate may be one-piece, or multi-piece with a garter spring. Some embodiments may be used with any kind of tangent ring between the radial ring (with pilot) and a cup face. Tangent ring types may include step-tangent (tangent to a diameter larger than the piston rod), true-tangent (tangent to the piston rod), tangent-to-rod (tangent to a diameter smaller than the piston rod) and 6-piece step-tangent (tangent to a diameter larger than the piston rod). Step-tangent, true-tangent, and tangent-to-rod rings may have at least one tangent segment. The radial ring with pilot feature may be replaced with any kind of tangent ring with pilot feature. As a result, the pair of tangent rings and radial rings with pilot feature may be a pair including a tangent ring and another tangent ring with pilot feature for the wave spring.

In some embodiments, on one or both sides of wave spring 202, the radial/tangent pair may be replaced with either a single pressure balanced ring with pilot feature, lip seal with pilot feature, or a single tangent-to-rod ring with pilot feature. A pressure balanced packing ring may be a single row of ring segments that are 3-dimensional in the plane of the ring. A tangent-to-rod ring may be configured to make a seal as a single ring until wear occurs. In addition, any or all of the rings may contain oil wiping edges at the inside diameter of the ring. Some embodiments may include at least one backup ring of either segmented (with at least one spring on the outer diameter) or solid design located between the tangent ring and the packing cup. Furthermore, the material of the radial ring, tangent ring, and spring plate may be any non-metallic or metallic material. The slot feature for alignment with the at least one peg may extend radially all the way across the radial thickness, and/or can be terminated at each end of the radial slot.

In certain embodiments, the slot feature may be machined at any angle other than radial to the ring. The slot feature may also be substituted by a hole for alignment with at least one peg and/or multiple slots and pegs may be used. The peg material may also be any non-metallic or metallic material, and the alignment of the rings via the peg may also be achieved by other means. The peg may be in the tangent ring, and the slot may be in the radial ring, but it may also be manufactured with the peg in the radial ring and the slot in the tangent ring. Furthermore, segmented packing rings may use coil springs, solid wire springs, o-rings, and/or any circumferential element around the outer diameter of the ring to keep the segments in close radial contact with the piston rod.

In various embodiments, at least one garter spring and/or at least one solid wire spring material may be any spring grade metal. The one-piece, multi-turn wave spring with flat end-coils may be composed of a variety of materials, such as carbon steel, chrome-silicon, stainless steel, super alloys, other metals, and/or non-metallics. The one-piece, multi-turn wave spring with flat end-coils may also have a small end treatment to at least one of the flat end coils to prevent rotation of the spring relative to the ring with pilot feature. In addition, the one-piece, multi-turn wave spring with flat end-coils may have partial flat end-coil or an absence of the flat end-coil.

In some embodiments, more than one wave spring can be used. For example, two or more wave springs may be nested together to boost axial load. Two or more wave springs may also be concentrically located relative to each other. In addition, two or more wave springs may be in series axial to each other. The purge ring set configuration may be used as a main/vent ring, where no purge gas is applied. The main/vent ring set may be used in a positive pressure purged packing if high flow rate flushing is needed. Furthermore, the piston rod may be any diameter.

The shaft sealing ring set may create and maintain close axial contact of the packing ring and oil wiper sets with the packing cup while eliminating the additional radial force of the wedge-activated designs. The design of the wave spring is such that it may generate axial force when compressed without creating any radial force. Eliminating the additional radial force from wedge-activated designs may cause less force being applied to the piston rod, leading to reduced friction of the piston rod, less heat, and less wear. The axial force generated by wave spring 202 may be greater than the force of friction between all of the individual rings on one side of wave spring 202, whichever side is greater, and the piston rod. The one-piece design of wave spring 202 may require few additional parts and no additional cups to enhance the current, or create new functions of particular ring sets. Wave spring 202 may be centered around the piston rod by at least one circumferential pilot from either the adjacent individual ring or packing cup. Quasi-uniform contact pressure from wave spring 202 may be applied to the adjacent rings or cups via the flat end coils. Packing ring sets or oil wiper sets with a one-piece wave spring are most easily installed or removed with the piston rod removed from the compressor. Thus, it is generally easiest to plunge the piston rod through the packing ring sets with at least one one-piece wave spring. Any ring sets containing solid rings or rings that are very stiff may require installation and removal with the piston rod removed from the compressor. Depending upon the design, flexibility, and strength of wave spring 202, it may be possible to wind wave spring 202 on or off the piston rod with the piston rod installed in the compressor.

One or more individual rings in a packing ring set may be configured to make a three-dimensional seal between the packing cup face and the piston rod shaft. Gas pressure may act in all directions, requiring a three-dimensional seal. As an example, certain applications may require that gas be sealed from migrating in one direction, while other applications may require that two different types of gas be sealed, each from migrating in opposite directions.

The sealing surfaces of packing ring sets may be held in close radial and circumferential contact with the piston rod by a spring on the outer diameter and close axial contact with the packing cup faces by wave spring 202. Close contact may be the relative distance between sealing surfaces. Close contact may exist when the distance between sealing surfaces is small enough that when the source of energization is applied, the surfaces press together to generate contact pressure. If close contact does not exist, the source of energization will not press the sealing surfaces together and/or will not generate contact pressure. When reciprocating piston rod motion does not exist, wave spring 202 may create and maintain the close axial contact between the packing ring set faces and the packing cup face. The packing ring set with wave spring 202 may be capable of sealing gas even when there is no reciprocating piston rod motion.

The design of most packing rings may be such that differential pressure is what energizes the packing rings to generate contact pressure between the sealing surfaces. Thus, packing rings may not self-energize. Using differential pressure to energize may regulate the contact pressure between sealing surfaces, which self-limits the heat and wear that is generated for the application. Low differential pressure may not be enough to energize the packing rings such that the spring on the outer diameter and the wave spring do all of the energizing in these examples.

Given the existence of reciprocating piston rod motion, the wave spring may maintain close axial contact between the packing ring set faces and the packing cup face, and may provide the energization when low differential pressure exists. Even with reciprocating piston rod motion, the packing ring set with wave spring may be capable of sealing low differential pressure gas.

A seal may be made when the contact pressure between sealing surfaces of the packing ring set and the cup face and piston rod is equal to or greater than the given differential pressure. There may be two types of cylinder differential gas pressure. First, cyclic differential gas pressure may be the difference between suction and discharge, which fluctuates with compression. Second, static differential gas pressure may be the difference between suction and atmosphere, which does not fluctuate. These two types of cylinder differential gas pressure may be used to maintain close contact of generally only two packing ring sets within the packing case. With no additional source of differential gas pressure to maintain close axial contact on more than two packing ring sets, wave spring 202 may provide the additional source of close axial contact. With more than two packing ring sets maintaining close axial contact, load sharing between more than two packing ring sets can be enabled, which is the breakdown of differential pressure over more than two packing ring sets.

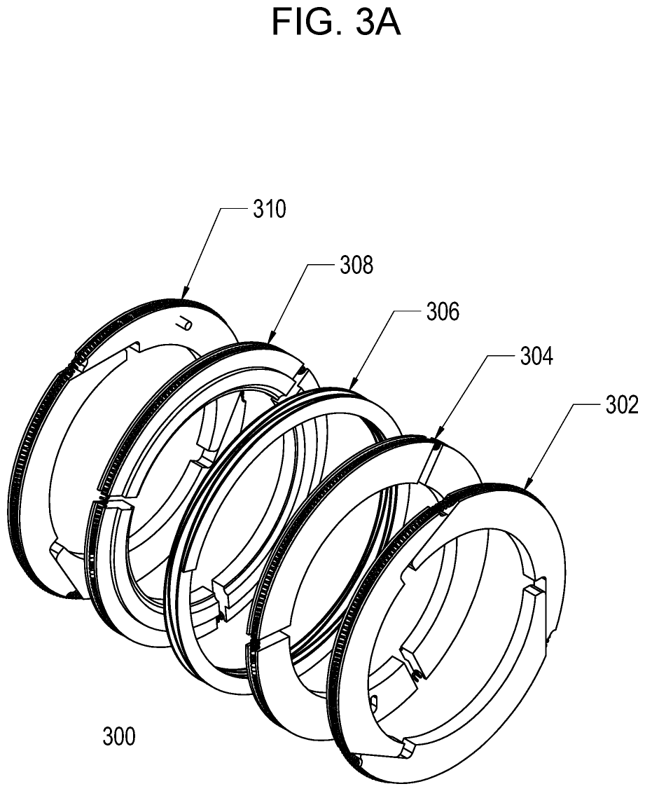

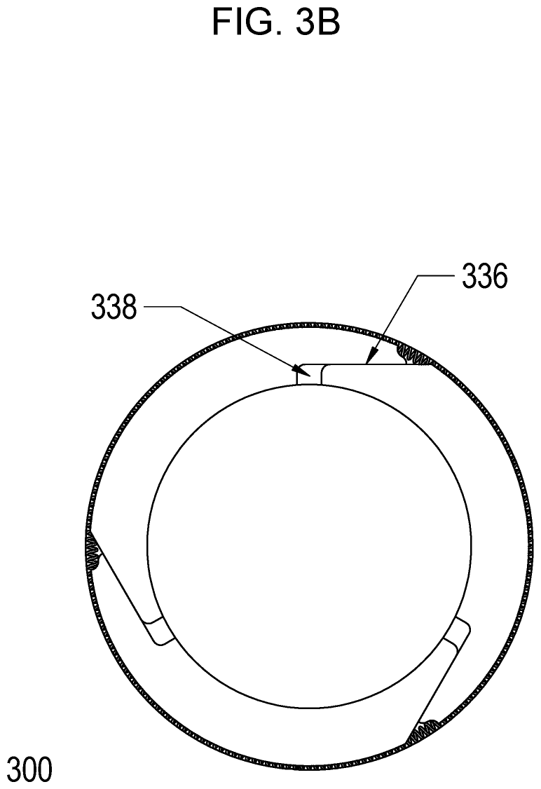

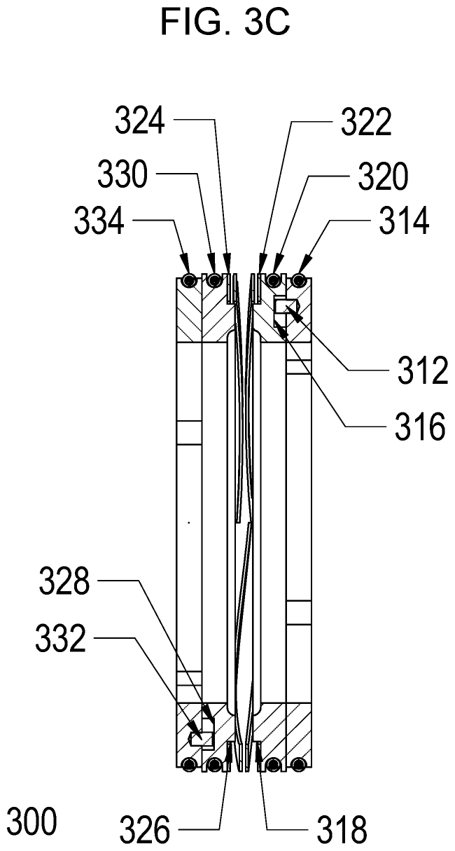

FIGS. 3A-3C illustrate an example of a bidirectional, packing purge ring set 300 configured to make a three-dimensional static or dynamic seal. One type of gas may be sealed from entering, and another type of gas may be sealed from exiting. Ring set 300 may include at least one 3-piece step-tangent packing ring 302 with at least one peg and/or at least one garter spring on the outer diameter, as shown in FIG. 3A.

Furthermore, ring set 300 may also include at least one adjacent 3-piece radial ring 304 with slot for alignment with the at least one peg in the step-tangent ring, at least one pilot for at least one wave spring and at least one garter spring on the outer diameter. Ring set 300 may also include at least one adjacent one-piece, multi-turn wave spring 306 with at least one flat end-coil that pilots on at least one adjacent ring. Additionally or alternatively, ring set 300 may include at least one adjacent 3-piece radial ring 308 with at least one pilot for wave spring 306, slot for alignment with the step-tangent ring, and a garter spring on the outer diameter. Ring set 300 may further include at least one adjacent 3-piece step-tangent ring 310 with at least one peg for alignment with radial ring and at least one garter spring on the outer diameter. FIG. 3B illustrates a top view of ring set 300 with tangential cut 336 and tangential end gap 338.

In various embodiments, as shown in FIG. 3C, element 302 may include one or more of at least one peg 312 configured to align with at least one slot in element 304, at least one garter spring 314 disposed on element 302. Element 304 may include at least one slot 316 configured to align with at least one peg in element 302. Furthermore, element 304 may include at least one pilot 318 configured to center with wave spring 306 and/or at least one garter spring 320. In addition, element 306 may include at least one flat end coil 322 and/or at least one flat end coil 324. Element 308 may also have at least one pilot 326 configured to center with wave spring 306. Slot 328 in element 308 may be configured to align with at least one peg in element 310, and element 308 may further include at least one garter spring 330. Similarly, element 310 may include at least one peg 332 to align with at least one slot in element 308, and/or may include at least one garter spring 334.

In various embodiments, any number, type, and/or combination of individual rings may be used on either one or both sides of wave spring 306. Radial rings, with or without pilot, may have any number of cuts. Thus, the radial ring may be 1-piece with a single end gap (cut), or composed of 2 or more segments with an equal number of end gaps (cuts). A vented spring plate may be one-piece, or multi-piece with a garter spring. Some embodiments may be used with any kind of tangent ring between the radial ring (with pilot) and a cup face. Tangent ring types may include step-tangent (tangent to a diameter larger than the piston rod), true-tangent (tangent to the piston rod), tangent-to-rod (tangent to a diameter smaller than the piston rod) and 6-piece step-tangent (tangent to a diameter larger than the piston rod). Step-tangent, true-tangent, and tangent-to-rod rings may have at least one tangent segment. The radial ring with pilot feature may be replaced with any kind of tangent ring with pilot feature. As a result, the pair of tangent rings and radial rings with pilot feature may be a pair including a tangent ring and another tangent ring with pilot feature for the wave spring.

In some embodiments, on one or both sides of wave spring 306, the radial/tangent pair may be replaced with either a single pressure balanced ring with pilot feature, lip seal with pilot feature, or a single tangent-to-rod ring with pilot feature. A pressure balanced packing ring may be a single row of ring segments that are 3-dimensional in the plane of the ring. A tangent-to-rod ring may be configured to make a seal as a single ring until wear occurs. In addition, any or all of the rings may contain oil wiping edges at the inside diameter of the ring. Some embodiments may include at least one backup ring of either segmented (with at least one spring on the outer diameter) or solid design located between the tangent ring and the packing cup. Furthermore, the material of the radial ring, tangent ring, and spring plate may be any non-metallic or metallic material. The slot feature for alignment with the at least one peg may extend radially all the way across the radial thickness, and/or can be terminated at each end of the radial slot.

In certain embodiments, the slot feature may be machined at any angle other than radial to the ring. The slot feature may also be substituted by a hole for alignment with at least one peg and/or multiple slots and pegs may be used. The peg material may also be any non-metallic or metallic material, and the alignment of the rings via the peg may also be achieved by other means. The peg may be in the tangent ring, and the slot may be in the radial ring, but it may also be manufactured with the peg in the radial ring and the slot in the tangent ring. Furthermore, segmented packing rings may use coil springs, solid wire springs, o-rings, and/or any circumferential element around the outer diameter of the ring to keep the segments in close radial contact with the piston rod.

In various embodiments, at least one garter spring and/or at least one solid wire spring material may be any spring grade metal. The one-piece, multi-turn wave spring with flat end-coils may be composed of a variety of materials, such as carbon steel, chrome-silicon, stainless steel, super alloys, other metals, and/or non-metallics. The one-piece, multi-turn wave spring with flat end-coils may also have a small end treatment to at least one of the flat end coils to prevent rotation of the spring relative to the ring with pilot feature. In addition, the one-piece, multi-turn wave spring with flat end-coils may have partial flat end-coil or an absence of the flat end-coil.

In some embodiments, more than one wave spring can be used. For example, two or more wave springs may be nested together to boost axial load. Two or more wave springs may also be concentrically located relative to each other. In addition, two or more wave springs may be in series axial to each other. The purge ring set configuration may be used as a main/vent ring, where no purge gas is applied. The main/vent ring set may be used in a positive pressure purged packing if high flow rate flushing is needed. Furthermore, the piston rod may be any diameter.

The shaft sealing ring set may create and maintain close axial contact of the packing ring and oil wiper sets with the packing cup while eliminating the additional radial force of the wedge-activated designs. The design of the wave spring is such that it may generate axial force when compressed without creating any radial force. Eliminating the additional radial force from wedge-activated designs may cause less force being applied to the piston rod, leading to reduced friction of the piston rod, less heat, and less wear. The axial force generated by wave spring 306 may be greater than the force of friction between all of the individual rings on one side of wave spring 306, whichever side is greater, and the piston rod. The one-piece design of wave spring 306 may require few additional parts and no additional cups to enhance the current, or create new functions of particular ring sets. Wave spring 306 may be centered around the piston rod by at least one circumferential pilot from either the adjacent individual ring or packing cup. Quasi-uniform contact pressure from wave spring 306 may be applied to the adjacent rings or cups via the flat end coils. Packing ring sets or oil wiper sets with a one-piece wave spring are most easily installed or removed with the piston rod removed from the compressor. Thus, it is generally easiest to plunge the piston rod through the packing ring sets with at least one one-piece wave spring. Any ring sets containing solid rings or rings that are very stiff may require installation and removal with the piston rod removed from the compressor. Depending upon the design, flexibility, and strength of wave spring 306, it may be possible to wind wave spring 306 on or off the piston rod with the piston rod installed in the compressor.

One or more individual rings in a packing ring set may be configured to make a three-dimensional seal between the packing cup face and the piston rod shaft. Gas pressure may act in all directions, requiring a three-dimensional seal. As an example, certain applications may require that gas be sealed from migrating in one direction, while other applications may require that two different types of gas be sealed, each from migrating in opposite directions.

The sealing surfaces of packing ring sets may be held in close radial and circumferential contact with the piston rod by a spring on the outer diameter and close axial contact with the packing cup faces by wave spring 306. Close contact may be the relative distance between sealing surfaces. Close contact may exist when the distance between sealing surfaces is small enough that when the source of energization is applied, the surfaces press together to generate contact pressure. If close contact does not exist, the source of energization will not press the sealing surfaces together and/or will not generate contact pressure. When reciprocating piston rod motion does not exist, wave spring 306 may create and maintain the close axial contact between the packing ring set faces and the packing cup face. The packing ring set with wave spring 306 may be capable of sealing gas even when there is no reciprocating piston rod motion.

The design of most packing rings may be such that differential pressure is what energizes the packing rings to generate contact pressure between the sealing surfaces. Thus, packing rings may not self-energize. Using differential pressure to energize may regulate the contact pressure between sealing surfaces, which self-limits the heat and wear that is generated for the application. Low differential pressure may not be enough to energize the packing rings such that the spring on the outer diameter and the wave spring do all of the energizing in these examples.

Given the existence of reciprocating piston rod motion, the wave spring may maintain close axial contact between the packing ring set faces and the packing cup face, and may provide the energization when low differential pressure exists. Even with reciprocating piston rod motion, the packing ring set with wave spring may be capable of sealing low differential pressure gas.

A seal may be made when the contact pressure between sealing surfaces of the packing ring set and the cup face and piston rod is equal to or greater than the given differential pressure. There may be two types of cylinder differential gas pressure. First, cyclic differential gas pressure may be the difference between suction and discharge, which fluctuates with compression. Second, static differential gas pressure may be the difference between suction and atmosphere, which does not fluctuate. These two types of cylinder differential gas pressure may be used to maintain close contact of generally only two packing ring sets within the packing case. With no additional source of differential gas pressure to maintain close axial contact on more than two packing ring sets, wave spring 306 may provide the additional source of close axial contact. With more than two packing ring sets maintaining close axial contact, load sharing between more than two packing ring sets can be enabled, which is the breakdown of differential pressure over more than two packing ring sets.

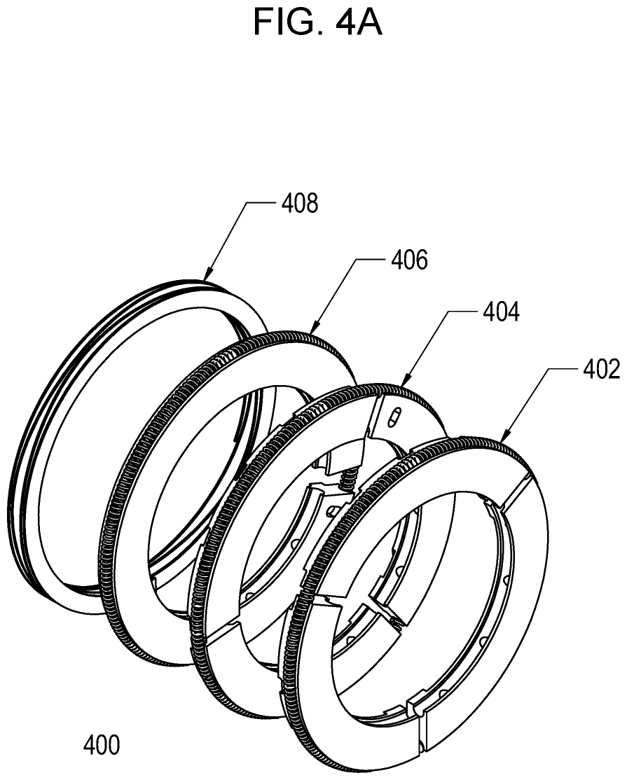

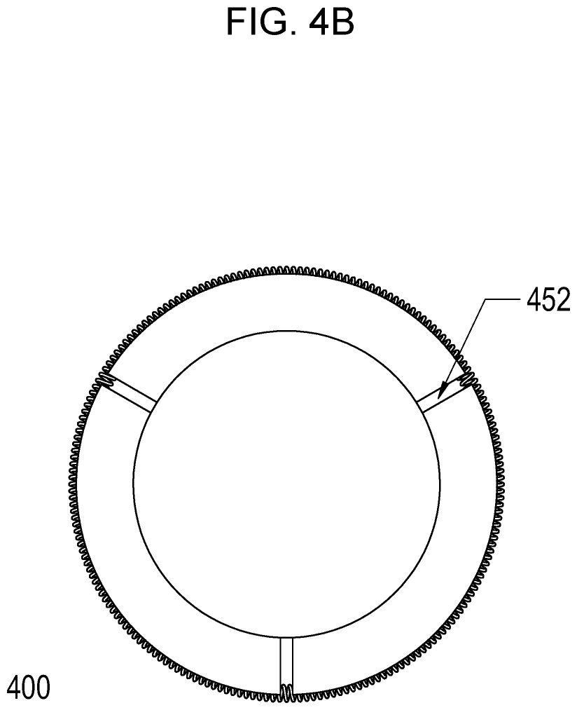

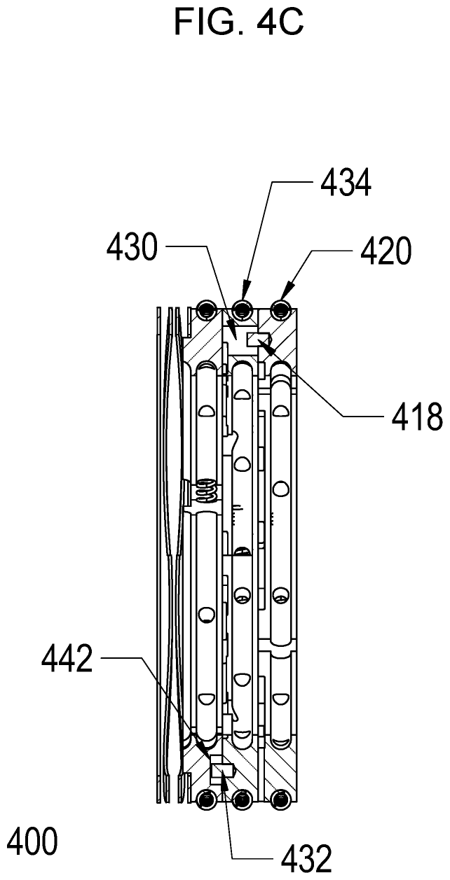

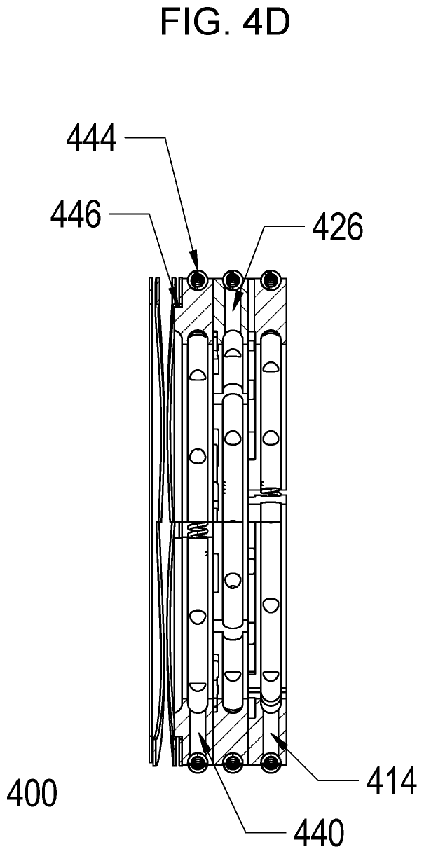

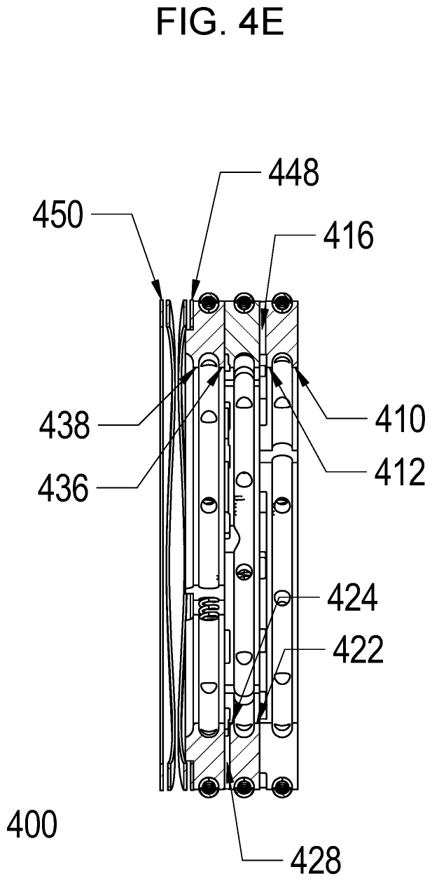

As shown in FIGS. 4A-4E, unidirectional oil wiper 400 is configured to make a two-dimensional dynamic seal. Unidirectional oil wiper 400 may include at least one 1 or 3-piece radial wiper ring (multiple inside diameter lands) 402 with at least one feature for radial venting of gas and/or draining of oil, at least one peg, and at least one garter spring on the outer diameter. In addition, unidirectional oil wiper 400 may include at least one adjacent 1 or 3-piece radial wiper ring 404 (multiple inside diameter lands) with at least one feature for radial venting of gas and draining of oil, a slot for alignment with the first element, at least one peg for aligning with the third element, and at least one garter spring on the outer diameter, as shown in FIG. 4A.

Unidirectional oil wiper 400 may also include at least one adjacent 1 or 3-piece radial wiper ring (multiple inside diameter lands) 406 with at least one feature for radial venting of gas and draining of oil, at least one slot for aligning with the second element, at least one garter spring on the outer diameter, and at least one pilot feature. Furthermore, unidirectional oil wiper 400 may include at least one adjacent one-piece, multi-turn wave spring 408 with at least one flat end-coil that pilots on the adjacent ring. FIG. 4B illustrates unidirectional oil wiper 400 with at least one radial end gap 452, which may be radially cut.

According to some embodiments, as shown in FIGS. 4C, 4D, and 4E, element 402 may include one or more of at least one wiping land 410, at least one wiping land 412, at least one radial drain hole 414, and at least one radial drain slot 416. Element 402 may also include at least one peg 418 configured to align with at least one slot in element 404 and/or at least one garter spring 420. Similarly, element 404 may also include one or more of at least one wiping land 422, at least one wiping land 424, at least one radial drain hole 426, and at least one radial drain slot 428. Element 404 may further include at least one slot 430 configured to align with at least one peg in element 402 and/or at least one peg 432 configured to align with at least one slot in element 406. Additionally, element 404 may include at least one garter spring 434, while element 406 may include at least one wiping land 436. Element 406 may further include at least one wiping land 438, at least one radial drain hole 440, and at least one slot 442 configured to align with at least one peg in element 404. In addition, in FIG. 4D, element 406 may also element 406 may include at least one garter spring 444 and/or at least one pilot 446 configured to center wave spring 408. Then, as shown in FIG. 4E, wave spring 408 may include at least one flat end coil 448 and/or at least one flat end coil 450.

In various embodiments, any number, type, and/or combination of individual rings may be used on either one or both sides of wave spring 408. Radial rings, with or without pilot, may have any number of cuts. Thus, the radial ring may be 1-piece with a single end gap (cut), or composed of 2 or more segments with an equal number of end gaps (cuts). A vented spring plate may be one-piece, or multi-piece with a garter spring. Some embodiments may be used with any kind of tangent ring between the radial ring (with pilot) and a cup face. Tangent ring types may include step-tangent (tangent to a diameter larger than the piston rod), true-tangent (tangent to the piston rod), tangent-to-rod (tangent to a diameter smaller than the piston rod) and 6-piece step-tangent (tangent to a diameter larger than the piston rod). Step-tangent, true-tangent, and tangent-to-rod rings may have at least one tangent segment. The radial ring with pilot feature may be replaced with any kind of tangent ring with pilot feature. As a result, the pair of tangent rings and radial rings with pilot feature may be a pair including a tangent ring and another tangent ring with pilot feature for the wave spring.

In some embodiments, on one or both sides of wave spring 408, the radial/tangent pair may be replaced with either a single pressure balanced ring with pilot feature, lip seal with pilot feature, or a single tangent-to-rod ring with pilot feature. A pressure balanced packing ring may be a single row of ring segments that are 3-dimensional in the plane of the ring. A tangent-to-rod ring may be configured to make a seal as a single ring until wear occurs. In addition, any or all of the rings may contain oil wiping edges at the inside diameter of the ring. Some embodiments may include at least one backup ring of either segmented (with at least one spring on the outer diameter) or solid design located between the tangent ring and the packing cup. Furthermore, the material of the radial ring, tangent ring, and spring plate may be any non-metallic or metallic material. The slot feature for alignment with the at least one peg may extend radially all the way across the radial thickness, and/or can be terminated at each end of the radial slot.

In certain embodiments, the slot feature may be machined at any angle other than radial to the ring. The slot feature may also be substituted by a hole for alignment with at least one peg and/or multiple slots and pegs may be used. The peg material may also be any non-metallic or metallic material, and the alignment of the rings via the peg may also be achieved by other means. The peg may be in the tangent ring, and the slot may be in the radial ring, but it may also be manufactured with the peg in the radial ring and the slot in the tangent ring. Furthermore, segmented packing rings may use coil springs, solid wire springs, o-rings, and/or any circumferential element around the outer diameter of the ring to keep the segments in close radial contact with the piston rod.

In various embodiments, at least one garter spring and/or at least one solid wire spring material may be any spring grade metal. The one-piece, multi-turn wave spring with flat end-coils may be composed of a variety of materials, such as carbon steel, chrome-silicon, stainless steel, super alloys, other metals, and/or non-metallics. The one-piece, multi-turn wave spring with flat end-coils may also have a small end treatment to at least one of the flat end coils to prevent rotation of the spring relative to the ring with pilot feature. In addition, the one-piece, multi-turn wave spring with flat end-coils may have partial flat end-coil or an absence of the flat end-coil.

In some embodiments, more than one wave spring can be used. For example, two or more wave springs may be nested together to boost axial load. Two or more wave springs may also be concentrically located relative to each other. In addition, two or more wave springs may be in series axial to each other. The purge ring set configuration may be used as a main/vent ring, where no purge gas is applied. The main/vent ring set may be used in a positive pressure purged packing if high flow rate flushing is needed. Furthermore, the piston rod may be any diameter.

The shaft sealing ring set may create and maintain close axial contact of the packing ring and oil wiper sets with the packing cup while eliminating the additional radial force of the wedge-activated designs. The design of the wave spring is such that it may generate axial force when compressed without creating any radial force. Eliminating the additional radial force from wedge-activated designs may cause less force being applied to the piston rod, leading to reduced friction of the piston rod, less heat, and less wear. The axial force generated by wave spring 408 may be greater than the force of friction between all of the individual rings on one side of wave spring 408, whichever side is greater, and the piston rod. The one-piece design of wave spring 408 may require few additional parts and no additional cups to enhance the current, or create new functions of particular ring sets. Wave spring 408 may be centered around the piston rod by at least one circumferential pilot from either the adjacent individual ring or packing cup. Quasi-uniform contact pressure from wave spring 408 may be applied to the adjacent rings or cups via the flat end coils. Packing ring sets or oil wiper sets with a one-piece wave spring are most easily installed or removed with the piston rod removed from the compressor. Thus, it is generally easiest to plunge the piston rod through the packing ring sets with at least one one-piece wave spring. Any ring sets containing solid rings or rings that are very stiff may require installation and removal with the piston rod removed from the compressor. Depending upon the design, flexibility, and strength of wave spring 408, it may be possible to wind wave spring 408 on or off the piston rod with the piston rod installed in the compressor.

The sealing surfaces of packing ring sets may be held in close radial and circumferential contact with the piston rod by a spring on the outer diameter and close axial contact with the packing cup faces by wave spring 408. Close contact may be the relative distance between sealing surfaces. Close contact may exist when the distance between sealing surfaces is small enough that when the source of energization is applied, the surfaces press together to generate contact pressure. If close contact does not exist, the source of energization will not press the sealing surfaces together and/or will not generate contact pressure. When reciprocating piston rod motion does not exist, wave spring 408 may create and maintain the close axial contact between the packing ring set faces and the packing cup face. The packing ring set with wave spring 408 may be capable of sealing gas even when there is no reciprocating piston rod motion.

The design of most packing rings may be such that differential pressure is what energizes the packing rings to generate contact pressure between the sealing surfaces. Thus, packing rings may not self-energize. Using differential pressure to energize may regulate the contact pressure between sealing surfaces, which self-limits the heat and wear that is generated for the application. Low differential pressure may not be enough to energize the packing rings such that the spring on the outer diameter and the wave spring do all of the energizing in these examples.

In an oil wiper set, one or more individual rings may be configured to make at least one two-dimensional seal axially and circumferentially between the packing rings, cup faces, and piston rod shaft. A two-dimensional seal may not be gas-tight and/or may have the potential to leak oil and gas, radially. Oil existing on the surface of the piston rod may be a two-dimensional, non-pressurized fluid. Oil may be scraped axially and circumferentially from the piston rod by scraping lands on the inner diameter of the wiper rings and/or may be drained radially away from the piston rod within the oil wiper set. Oil may be scraped from the piston rod because high contact pressure between the scraping lands and the piston rod overcomes the natural tendency of the oil to adhere to the piston rod. The spring on the outer diameter of the rings and the wave spring may create and maintain close contact and/or energize the oil wiper. In other words, oil wiper sets may be spring-energized.

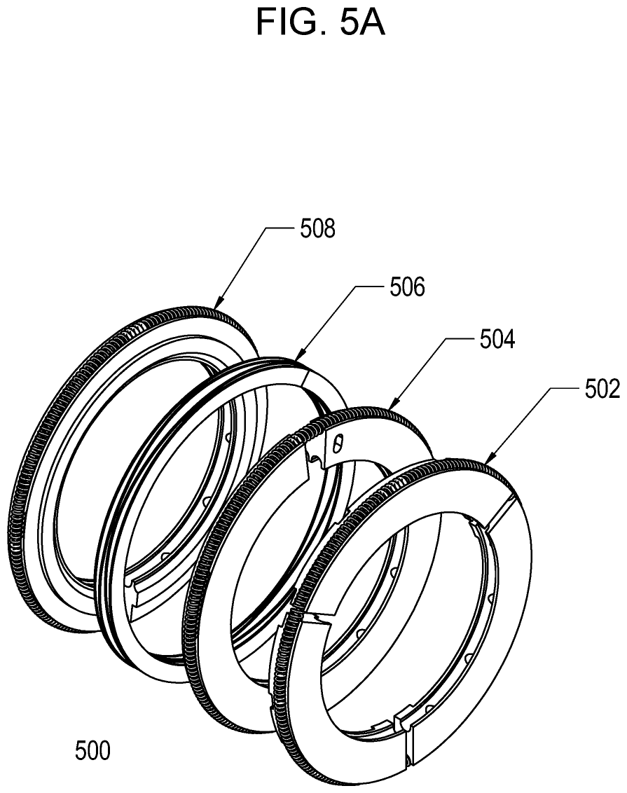

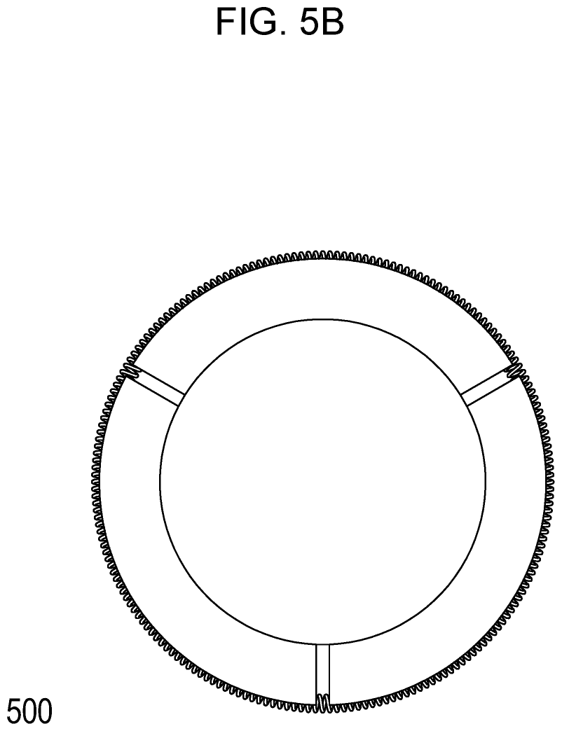

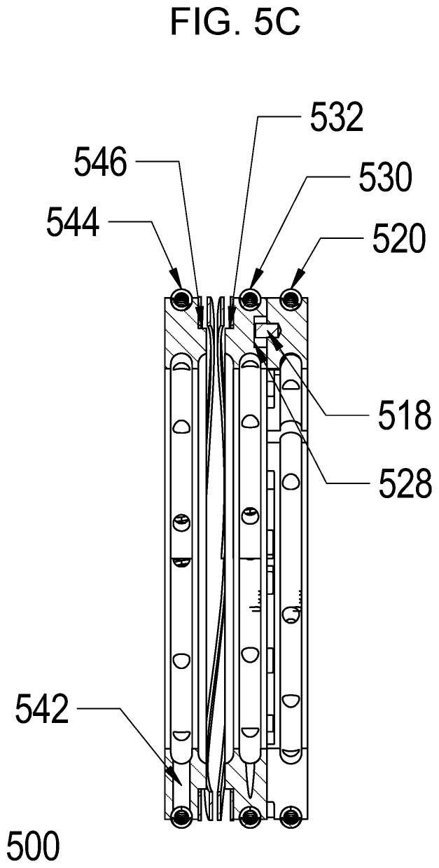

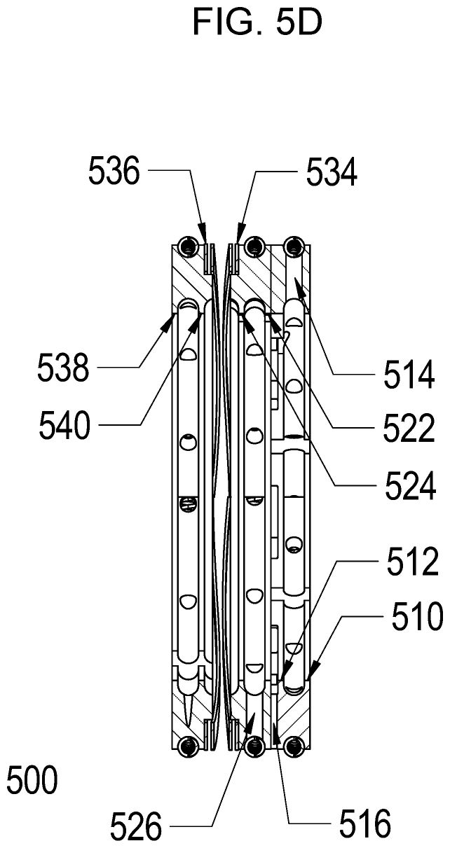

FIGS. 5A-5D illustrate an example of unidirectional oil wiper 500 configured to make a two-dimensional dynamic seal. Unidirectional oil wiper 500 may include at least one 1 or 3-piece radial wiper ring 502 (multiple inside diameter lands) with features for radial venting of gas and draining of oil, at least one peg, and at least one garter spring on the outer diameter. Additionally or alternatively, unidirectional oil wiper 500 may include at least one adjacent 1 or 3-piece radial wiper ring 504 (multiple inside diameter lands) with features for radial venting of gas and draining of oil, at least one slot for alignment with the first element, at least one garter spring on the outer diameter, and at least one pilot feature for the wave spring. FIG. 5A illustrates an exploded view of a second example of a unidirectional oil wiper according to certain embodiments, while FIG. 5B illustrates a top view of the second example of a unidirectional oil wiper according to some embodiments.

Unidirectional oil wiper 500 may also include at least one adjacent one-piece, multi-turn wave spring 506 with at least one flat end-coil that pilots on the adjacent rings. Furthermore, unidirectional oil wiper 500 may include at least one adjacent 1 or 3-piece radial wiper ring 508 (multiple inside diameter lands) with at least one feature for radial venting of gas and draining of oil, at least one garter spring on the outer diameter, and at least one pilot feature.

In various embodiments, any number, type, and/or combination of individual rings may be used on either one or both sides of wave spring 506. Radial rings, with or without pilot, may have any number of cuts. Thus, the radial ring may be 1-piece with a single end gap (cut), or composed of 2 or more segments with an equal number of end gaps (cuts). A vented spring plate may be one-piece, or multi-piece with a garter spring. Some embodiments may be used with any kind of tangent ring between the radial ring (with pilot) and a cup face. Tangent ring types may include step-tangent (tangent to a diameter larger than the piston rod), true-tangent (tangent to the piston rod), tangent-to-rod (tangent to a diameter smaller than the piston rod) and 6-piece step-tangent (tangent to a diameter larger than the piston rod). Step-tangent, true-tangent, and tangent-to-rod rings may have at least one tangent segment. The radial ring with pilot feature may be replaced with any kind of tangent ring with pilot feature. As a result, the pair of tangent rings and radial rings with pilot feature may be a pair including a tangent ring and another tangent ring with pilot feature for the wave spring.

In certain embodiments, as illustrated by FIGS. 5C and 5D, element 502 may include at least one peg 518 configured to align with at least one slot in element 504, while element 502 may include at least one garter spring 520. Element 504 may further include one or more of at least one garter spring 530, at least one pilot 532 configured to center with wave spring 506, and at least one slot 528 configured to align with at least one peg in element 502. Element 508 may also include one or more of at least one radial drain hole 542, at least one garter spring 544, and at least one pilot 546 configured to center wave spring 506. As shown in FIG. 5D, element 502 may include one or more of at least one wiping land 510, at least one wiping land 512, at least one radial drain hole 514, and at least one radial drain slot 516. Element 504 may also have one or more of at least one wiping land 522, at least one wiping land 524, and at least one radial drain hole 526. Wave spring 506 may include flat end coil 534 and/or flat end coil 536, while element 508 may include one or more of at least one wiping land 538 and/or at least one wiping land 540.

In some embodiments, on one or both sides of wave spring 506, the radial/tangent pair may be replaced with either a single pressure balanced ring with pilot feature, lip seal with pilot feature, or a single tangent-to-rod ring with pilot feature. A pressure balanced packing ring may be a single row of ring segments that are 3-dimensional in the plane of the ring. A tangent-to-rod ring may be configured to make a seal as a single ring until wear occurs. In addition, any or all of the rings may contain oil wiping edges at the inside diameter of the ring. Some embodiments may include at least one backup ring of either segmented (with at least one spring on the outer diameter) or solid design located between the tangent ring and the packing cup. Furthermore, the material of the radial ring, tangent ring, and spring plate may be any non-metallic or metallic material. The slot feature for alignment with the at least one peg may extend radially all the way across the radial thickness, and/or can be terminated at each end of the radial slot.

In certain embodiments, the slot feature may be machined at any angle other than radial to the ring. The slot feature may also be substituted by a hole for alignment with at least one peg and/or multiple slots and pegs may be used. The peg material may also be any non-metallic or metallic material, and the alignment of the rings via the peg may also be achieved by other means. The peg may be in the tangent ring, and the slot may be in the radial ring, but it may also be manufactured with the peg in the radial ring and the slot in the tangent ring. Furthermore, segmented packing rings may use coil springs, solid wire springs, o-rings, and/or any circumferential element around the outer diameter of the ring to keep the segments in close radial contact with the piston rod.

In various embodiments, at least one garter spring and/or at least one solid wire spring material may be any spring grade metal. The one-piece, multi-turn wave spring with flat end-coils may be composed of a variety of materials, such as carbon steel, chrome-silicon, stainless steel, super alloys, other metals, and/or non-metallics. The one-piece, multi-turn wave spring with flat end-coils may also have a small end treatment to at least one of the flat end coils to prevent rotation of the spring relative to the ring with pilot feature. In addition, the one-piece, multi-turn wave spring with flat end-coils may have partial flat end-coil or an absence of the flat end-coil.

In some embodiments, more than one wave spring can be used. For example, two or more wave springs may be nested together to boost axial load. Two or more wave springs may also be concentrically located relative to each other. In addition, two or more wave springs may be in series axial to each other. The purge ring set configuration may be used as a main/vent ring, where no purge gas is applied. The main/vent ring set may be used in a positive pressure purged packing if high flow rate flushing is needed. Furthermore, the piston rod may be any diameter.

The shaft sealing ring set may create and maintain close axial contact of the packing ring and oil wiper sets with the packing cup while eliminating the additional radial force of the wedge-activated designs. The design of the wave spring is such that it may generate axial force when compressed without creating any radial force. Eliminating the additional radial force from wedge-activated designs may cause less force being applied to the piston rod, leading to reduced friction of the piston rod, less heat, and less wear. The axial force generated by wave spring 506 may be greater than the force of friction between all of the individual rings on one side of wave spring 506, whichever side is greater, and the piston rod. The one-piece design of wave spring 506 may require few additional parts and no additional cups to enhance the current, or create new functions of particular ring sets. Wave spring 506 may be centered around the piston rod by at least one circumferential pilot from either the adjacent individual ring or packing cup. Quasi-uniform contact pressure from wave spring 506 may be applied to the adjacent rings or cups via the flat end coils. Packing ring sets or oil wiper sets with a one-piece wave spring are most easily installed or removed with the piston rod removed from the compressor. Thus, it is generally easiest to plunge the piston rod through the packing ring sets with at least one one-piece wave spring. Any ring sets containing solid rings or rings that are very stiff may require installation and removal with the piston rod removed from the compressor. Depending upon the design, flexibility, and strength of wave spring 506, it may be possible to wind wave spring 506 on or off the piston rod with the piston rod installed in the compressor.

The sealing surfaces of packing ring sets may be held in close radial and circumferential contact with the piston rod by a spring on the outer diameter and close axial contact with the packing cup faces by wave spring 506. Close contact may be the relative distance between sealing surfaces. Close contact may exist when the distance between sealing surfaces is small enough that when the source of energization is applied, the surfaces press together to generate contact pressure. If close contact does not exist, the source of energization will not press the sealing surfaces together and/or will not generate contact pressure. When reciprocating piston rod motion does not exist, wave spring 506 may create and maintain the close axial contact between the packing ring set faces and the packing cup face. The packing ring set with wave spring 506 may be capable of sealing gas even when there is no reciprocating piston rod motion.

The design of most packing rings may be such that differential pressure is what energizes the packing rings to generate contact pressure between the sealing surfaces. Thus, packing rings may not self-energize. Using differential pressure to energize may regulate the contact pressure between sealing surfaces, which self-limits the heat and wear that is generated for the application. Low differential pressure may not be enough to energize the packing rings such that the spring on the outer diameter and the wave spring do all of the energizing in these examples.

In an oil wiper set, one or more individual rings may be configured to make at least one two-dimensional seal axially and circumferentially between the packing rings, cup faces, and piston rod shaft. A two-dimensional seal may not be gas-tight and/or may have the potential to leak oil and gas, radially. Oil existing on the surface of the piston rod may be a two-dimensional, non-pressurized fluid. Oil may be scraped axially and circumferentially from the piston rod by scraping lands on the inner diameter of the wiper rings and/or may be drained radially away from the piston rod within the oil wiper set. Oil may be scraped from the piston rod because high contact pressure between the scraping lands and the piston rod overcomes the natural tendency of the oil to adhere to the piston rod. The spring on the outer diameter of the rings and the wave spring may create and maintain close contact and/or energize the oil wiper. In other words, oil wiper sets may be spring-energized.

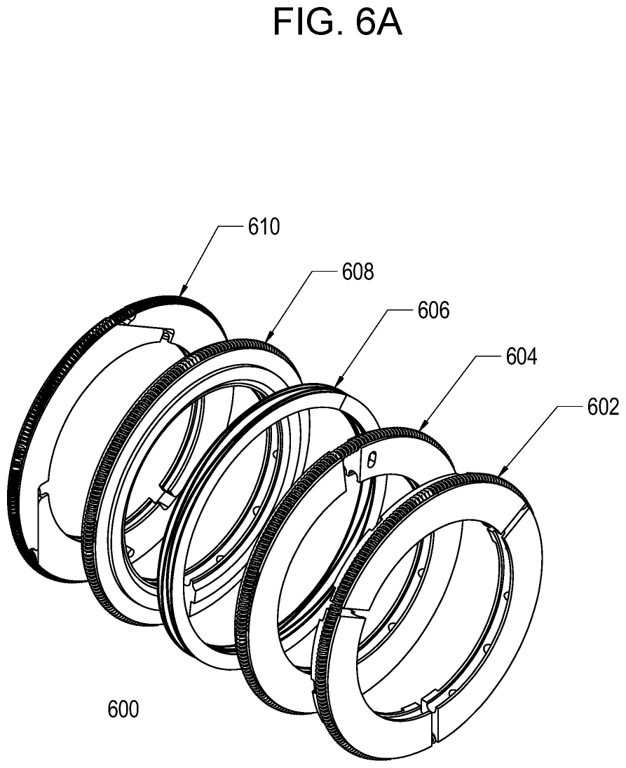

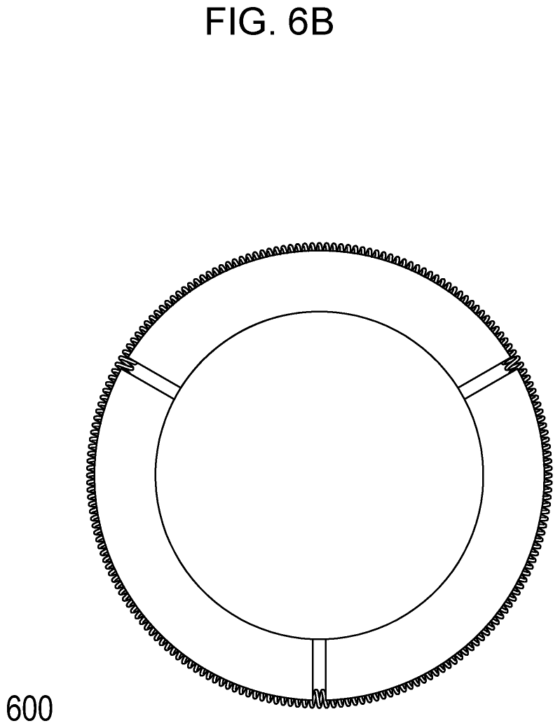

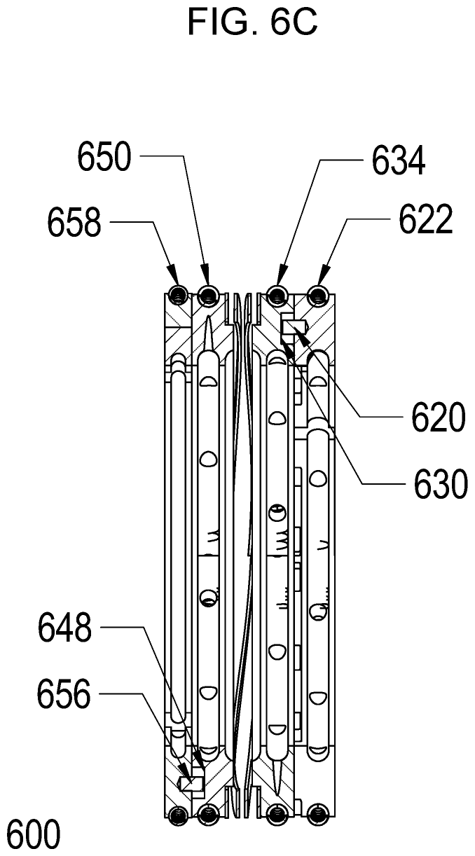

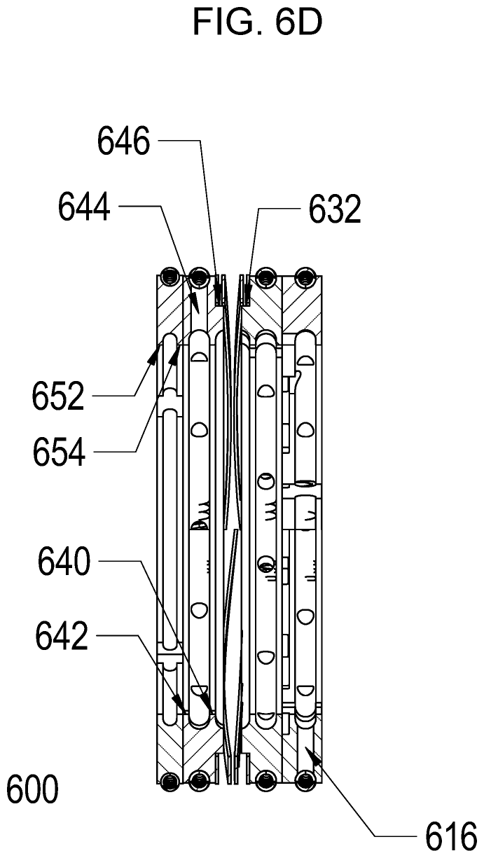

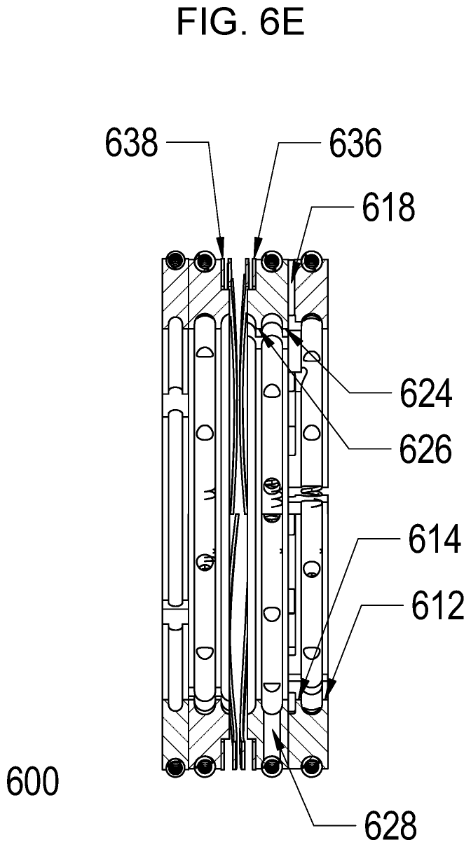

FIGS. 6A-6E illustrate an example of a multi-function, bidirectional oil wiper 600 configured to make a two/three-dimensional static or dynamic seal. Oil wiper 600 may include at least one 1 or 3-piece radial wiper ring 602 (multiple inside diameter lands) with at least one feature for radial venting of gas and draining of oil, at least one peg, and at least one garter spring on the outer diameter. Additionally or alternatively, oil wiper 600 may include at least one adjacent 1 or 3-piece radial wiper ring 604 (multiple inside diameter lands) with at least one feature for radial venting of gas and draining of oil, at least one slot for alignment with the first element, at least one pilot for the wave spring, and at least one garter spring on the outer diameter. FIG. 6A illustrates an exploded view of an example of a multi-function, bidirectional oil wiper according to some embodiments, while FIG. 6B illustrates a top view of the example of a multi-function, bidirectional oil wiper according to some embodiments.

Oil wiper 600 may also include at least one adjacent one-piece multi-turn wave spring 606 with at least one flat end-coil that pilots on the adjacent rings. Furthermore, oil wiper 600 may include at least one adjacent 1 or 3-piece radial wiper ring 608 (multiple inside diameter lands) with at least one feature for radial venting of gas and draining of oil, at least one pilot feature for alignment with the wave spring, at least one slot for alignment, and at least one garter spring on the outer diameter. Oil wiper 600 may further include at least one adjacent 3-piece step-tangent ring 610 with multiple inside diameter wiping lands, at least one peg for alignment with the fourth element, and at least one garter spring on the outer diameter.

According to various embodiments, as shown in FIGS. 6C, 6D, and 6E, element 602 may include at least one peg 620 configured to align with at least one slot in element 604 and/or at least one garter spring 622. Element 604 may also include slot 630 configured to align with at least one peg in element 602, as well as garter spring 634. Element 608 may further include one or more of at least one slot 648 configured to align with at least one peg in element 610 and/or at least one garter spring 650. Element 610 may include at least one garter spring 658 and/or at least one peg 656 configured to align with at least one slot in element 608. FIG. 6D illustrates element 602 having at least one radial drain hole 616, while element 604 may include at least one pilot 632 configured to center wave spring 606. Element 608 may further include one or more of at least one wiping land 640, at least one wiping land 642, at least one radial drain hole 644, and at least one pilot 646 configured to center wave spring 606. Element 610 may include at least one wiping land 652 and/or at least one wiping land 654. As shown in FIG. 6E, element 602 may include one or more of at least one wiping land 612, at least one wiping land 614, and at least one radial drain slot 618. Similarly, element 604 may include one or more of at least one wiping land 624, at least one wiping land 626, and at least one radial drain hole 628. Wave spring 606 may further include at least one flat end coil 636 and/or at least one flat end coil 638.

In various embodiments, any number, type, and/or combination of individual rings may be used on either one or both sides of wave spring 606. Radial rings, with or without pilot, may have any number of cuts. Thus, the radial ring may be 1-piece with a single end gap (cut), or composed of 2 or more segments with an equal number of end gaps (cuts). A vented spring plate may be one-piece, or multi-piece with a garter spring. Some embodiments may be used with any kind of tangent ring between the radial ring (with pilot) and a cup face. Tangent ring types may include step-tangent (tangent to a diameter larger than the piston rod), true-tangent (tangent to the piston rod), tangent-to-rod (tangent to a diameter smaller than the piston rod) and 6-piece step-tangent (tangent to a diameter larger than the piston rod). Step-tangent, true-tangent, and tangent-to-rod rings may have at least one tangent segment. The radial ring with pilot feature may be replaced with any kind of tangent ring with pilot feature. As a result, the pair of tangent rings and radial rings with pilot feature may be a pair including a tangent ring and another tangent ring with pilot feature for the wave spring.

In some embodiments, on one or both sides of wave spring 606, the radial/tangent pair may be replaced with either a single pressure balanced ring with pilot feature, lip seal with pilot feature, or a single tangent-to-rod ring with pilot feature. A pressure balanced packing ring may be a single row of ring segments that are 3-dimensional in the plane of the ring. A tangent-to-rod ring may be configured to make a seal as a single ring until wear occurs. In addition, any or all of the rings may contain oil wiping edges at the inside diameter of the ring. Some embodiments may include at least one backup ring of either segmented (with at least one spring on the outer diameter) or solid design located between the tangent ring and the packing cup. Furthermore, the material of the radial ring, tangent ring, and spring plate may be any non-metallic or metallic material. The slot feature for alignment with the at least one peg may extend radially all the way across the radial thickness, and/or can be terminated at each end of the radial slot.

In certain embodiments, the slot feature may be machined at any angle other than radial to the ring. The slot feature may also be substituted by a hole for alignment with at least one peg and/or multiple slots and pegs may be used. The peg material may also be any non-metallic or metallic material, and the alignment of the rings via the peg may also be achieved by other means. The peg may be in the tangent ring, and the slot may be in the radial ring, but it may also be manufactured with the peg in the radial ring and the slot in the tangent ring. Furthermore, segmented packing rings may use coil springs, solid wire springs, o-rings, and/or any circumferential element around the outer diameter of the ring to keep the segments in close radial contact with the piston rod.

In various embodiments, at least one garter spring and/or at least one solid wire spring material may be any spring grade metal. The one-piece, multi-turn wave spring with flat end-coils may be composed of a variety of materials, such as carbon steel, chrome-silicon, stainless steel, super alloys, other metals, and/or non-metallics. The one-piece, multi-turn wave spring with flat end-coils may also have a small end treatment to at least one of the flat end coils to prevent rotation of the spring relative to the ring with pilot feature. In addition, the one-piece, multi-turn wave spring with flat end-coils may have partial flat end-coil or an absence of the flat end-coil.

In some embodiments, more than one wave spring can be used. For example, two or more wave springs may be nested together to boost axial load. Two or more wave springs may also be concentrically located relative to each other. In addition, two or more wave springs may be in series axial to each other. The purge ring set configuration may be used as a main/vent ring, where no purge gas is applied. The main/vent ring set may be used in a positive pressure purged packing if high flow rate flushing is needed. Furthermore, the piston rod may be any diameter.

The shaft sealing ring set may create and maintain close axial contact of the packing ring and oil wiper sets with the packing cup while eliminating the additional radial force of the wedge-activated designs. The design of the wave spring is such that it may generate axial force when compressed without creating any radial force. Eliminating the additional radial force from wedge-activated designs may cause less force being applied to the piston rod, leading to reduced friction of the piston rod, less heat, and less wear. The axial force generated by wave spring 606 may be greater than the force of friction between all of the individual rings on one side of wave spring 606, whichever side is greater, and the piston rod. The one-piece design of wave spring 606 may require few additional parts and no additional cups to enhance the current, or create new functions of particular ring sets. Wave spring 606 may be centered around the piston rod by at least one circumferential pilot from either the adjacent individual ring or packing cup. Quasi-uniform contact pressure from wave spring 606 may be applied to the adjacent rings or cups via the flat end coils. Packing ring sets or oil wiper sets with a one-piece wave spring are most easily installed or removed with the piston rod removed from the compressor. Thus, it is generally easiest to plunge the piston rod through the packing ring sets with at least one one-piece wave spring. Any ring sets containing solid rings or rings that are very stiff may require installation and removal with the piston rod removed from the compressor. Depending upon the design, flexibility, and strength of wave spring 606, it may be possible to wind wave spring 606 on or off the piston rod with the piston rod installed in the compressor.

One or more individual rings in a packing ring set may be configured to make a three-dimensional seal between the packing cup face and the piston rod shaft. Gas pressure may act in all directions, requiring a three-dimensional seal. As an example, certain applications may require that gas be sealed from migrating in one direction, while other applications may require that two different types of gas be sealed, each from migrating in opposite directions.

The sealing surfaces of packing ring sets may be held in close radial and circumferential contact with the piston rod by a spring on the outer diameter and close axial contact with the packing cup faces by wave spring 606. Close contact may be the relative distance between sealing surfaces. Close contact may exist when the distance between sealing surfaces is small enough that when the source of energization is applied, the surfaces press together to generate contact pressure. If close contact does not exist, the source of energization will not press the sealing surfaces together and/or will not generate contact pressure. When reciprocating piston rod motion does not exist, wave spring 606 may create and maintain the close axial contact between the packing ring set faces and the packing cup face. The packing ring set with wave spring 606 may be capable of sealing gas even when there is no reciprocating piston rod motion.

The design of most packing rings may be such that differential pressure is what energizes the packing rings to generate contact pressure between the sealing surfaces. Thus, packing rings may not self-energize. Using differential pressure to energize may regulate the contact pressure between sealing surfaces, which self-limits the heat and wear that is generated for the application. Low differential pressure may not be enough to energize the packing rings such that the spring on the outer diameter and the wave spring do all of the energizing in these examples.

Given the existence of reciprocating piston rod motion, the wave spring may maintain close axial contact between the packing ring set faces and the packing cup face, and may provide the energization when low differential pressure exists. Even with reciprocating piston rod motion, the packing ring set with wave spring may be capable of sealing low differential pressure gas.

A seal may be made when the contact pressure between sealing surfaces of the packing ring set and the cup face and piston rod is equal to or greater than the given differential pressure. There may be two types of cylinder differential gas pressure. First, cyclic differential gas pressure may be the difference between suction and discharge, which fluctuates with compression. Second, static differential gas pressure may be the difference between suction and atmosphere, which does not fluctuate. These two types of cylinder differential gas pressure may be used to maintain close contact of generally only two packing ring sets within the packing case. With no additional source of differential gas pressure to maintain close axial contact on more than two packing ring sets, wave spring 606 may provide the additional source of close axial contact. With more than two packing ring sets maintaining close axial contact, load sharing between more than two packing ring sets can be enabled, which is the breakdown of differential pressure over more than two packing ring sets.

In an oil wiper set, one or more individual rings may be configured to make at least one two-dimensional seal axially and circumferentially between the packing rings, cup faces, and piston rod shaft. A two-dimensional seal may not be gas-tight and/or may have the potential to leak oil and gas, radially. Oil existing on the surface of the piston rod may be a two-dimensional, non-pressurized fluid. Oil may be scraped axially and circumferentially from the piston rod by scraping lands on the inner diameter of the wiper rings and/or may be drained radially away from the piston rod within the oil wiper set. Oil may be scraped from the piston rod because high contact pressure between the scraping lands and the piston rod overcomes the natural tendency of the oil to adhere to the piston rod. The spring on the outer diameter of the rings and the wave spring may create and maintain close contact and/or energize the oil wiper. In other words, oil wiper sets may be spring-energized.

Oil wiper individual rings may be configured to add a radial component of sealing that produces a three-dimensional seal having even less oil migration in one direction. The oil wiper set configuration to make a three-dimensional seal may still scrape oil axially and circumferentially from the piston rod and drains radially internal to the wiper, but may also prevent oil from wicking along interior cup surfaces past the oil wiper set in one direction. A three-dimensional oil wiper set may also seal low differential pressure gas from migrating in the opposite direction.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

We claim:

1. An apparatus, comprising:
a sealing element comprising at least one pilot feature on a first face, and at least one device configured to apply radial force on an outer diameter of the sealing element; and
at least one wave spring comprising at least one flat end-coil and disposed around the at least one pilot feature of the sealing element.

2. The apparatus of claim 1, wherein the at least one device configured to apply radial force of the sealing element comprises one or more of at least one garter spring, at least one wire spring, and at least one o-ring.

3. The apparatus of claim 1, wherein the sealing element comprises any combination of pressure-balanced, tangent-to-rod ring, lip seal, or lip seal with carrier, with at least one pilot feature.

4. The apparatus of claim 1, wherein the sealing element comprises at least one of:
a first ring comprising at least one pilot feature on a first face, at least one first feature on a second face, and at least one device configured to apply radial force on an outer diameter of the first ring; and
a second ring comprising at least one second feature configured to align with the at least one first feature and at least one device configured to apply radial force on an outer diameter of the second ring.

5. The apparatus of claim 4, wherein one or more of the at least one device configured to apply radial force of the first ring or the at least one device configured to apply radial force of the second ring comprises one or more of at least one garter spring, at least one wire spring, and at least one o-ring.

6. The apparatus of claim 4, wherein one or more of the first ring or the second ring further comprises:
one or more of at least one radial ring segment;
one or more of at least one tangentially-cut ring segment; and
at least one pilot.

7. The apparatus of claim 4, wherein one or more of the first ring or the second ring further comprise at least one wiping land disposed on the interior diameter of the respective ring and configured to transfer oil.

8. The apparatus of claim 4, wherein one or more of the first ring or the second ring further comprises:
the at least one first feature is a protuberance, and the at least one second feature is a slot feature, hole feature, or slot-terminated feature; or
the at least one second feature is a protuberance, and the at least one first feature is a slot feature, hole feature, or slot-terminated feature.

9. An apparatus, comprising:
a first sealing element comprising at least one pilot feature on a first face, and at least one device configured to apply radial force on an outer diameter of the first sealing element;
a wave spring comprising at least one flat end-coil and disposed adjacent to the first face of the first sealing element; and
a second sealing element comprising at least one pilot disposed on a first face adjacent to the wave spring, and at least one device configured to apply radial force on an outer diameter of the second sealing element.

10. The apparatus of claim 9, wherein the at least one device configured to apply radial force of the first sealing element, and the at least one device configured to apply radial force of the second sealing element comprises one or more of at least one garter spring, at least one wire spring, and at least one o-ring.

11. The apparatus of claim 9, wherein one or more of the first or second sealing element is any combination of pressure-balanced, tangent-to-rod ring, lip seal, or lip seal with carrier, with at least one pilot feature.

12. The apparatus of claim 9, wherein the first sealing element comprises at least one of:
a first ring comprising at least one first feature and at least one device configured to apply radial force on an outer diameter of the first ring; and
a second ring comprising at least one second feature disposed on a first face of the second ring and configured to align with the first feature, at least one pilot feature on a second face, and at least one device configured to apply radial force on an outer diameter of the second ring.

13. The apparatus of claim 12, wherein one or more of the at least one device configured to apply radial force of the first ring or the at least one device configured to apply radial force of the second ring comprises one or more of at least one garter spring, at least one wire spring, and at least one o-ring.

14. The apparatus of claim 12, wherein one or more of the first ring or the second ring further comprises:
one or more of at least one radial ring segment;
one or more of at least one tangentially-cut ring segment; and
at least one pilot.

15. The apparatus of claim 12, wherein one or more of the first ring or the second ring further comprise at least one wiping land disposed on the interior diameter of the respective ring and configured to transfer oil.

16. The apparatus of claim 12, wherein one or more of the first ring or the second ring further comprises:
the at least one first feature is a protuberance, and the at least one second feature is a slot feature, hole feature, or slot-terminated feature; or
the at least one second feature is a protuberance, and the at least one first feature is a slot feature, hole feature, or slot-terminated feature.

17. The apparatus of claim 9, wherein the second sealing element comprises at least one of:
a third ring comprising at least one pilot disposed on a first face, at least one third feature disposed on a second face, and at least one device configured to apply radial force on an outer diameter of the third ring; and
a fourth ring comprising at least one fourth feature configured for alignment with the at least one third feature of the third ring, and at least one device configured to apply radial force on an outer diameter of the fourth ring.

18. The apparatus of claim 17, wherein one or more of the at least one device configured to apply radial force of the third ring or the at least one device configured to apply radial force of the fourth ring comprises one or more of at least one garter spring, at least one wire spring, and at least one o-ring.

19. The apparatus of claim 17, wherein one or more of the third ring or the fourth ring further comprises:
one or more of at least one radial ring segment;
one or more of at least one tangentially-cut ring segment; and
at least one pilot.

20. The apparatus of claim 17, wherein one or more of the third ring or the fourth ring further comprise at least one wiping land disposed on the interior diameter of the respective ring and configured to transfer oil.

21. The apparatus of claim 17, wherein:
the at least one third feature is a protuberance, and the at least one fourth feature is a slot feature, hole feature, or slot-terminated feature; or
the at least one fourth feature is a protuberance, and the at least one third feature is a slot feature, hole feature, or slot-terminated feature.
